(19) United States
(12) Patent Application Publication
(10) Pub. No.: US 2012/0257838 A1
(43) Pub. Date: Oct. 11, 2012

(54) IMAGE DECODING APPARATUS AND IMAGE DECODING METHOD

(75) Inventors: Masao KITAGAWA, Hyogo (JP); Satoshi Yamaguchi, Hyogo (JP)

(73) Assignee: PANASONIC CORPORATION, Osaka (JP)

(21) Appl. No.: 13/494,790

(22) Filed: Jun. 12, 2012

Related U.S. Application Data
(63) Continuation of application No. PCT/JP2010/004081, filed on Jun. 18, 2010.

(30) Foreign Application Priority Data
Dec. 14, 2009 (JP) 2009-283354

(51) Int. Cl. G06K 9/36

(52) U.S. Cl. 382/233

(57) ABSTRACT

An image decoding apparatus according to one aspect of the present invention includes: a management information storage unit that stores first management information for identifying areas in each of which one of first decoded image signals is stored, and second management information for identifying areas in each of which one of second decoded image signals is stored; and a control unit that notifies, by referring to the first management information, an image decoding unit of an area in which a reference image to be referred to when a first coded signal is decoded is stored, and notifies, by referring to the first management information and the second management information, the image decoding unit of an area in which a reference image to be referred to when a second coded signal is decoded is stored.

### CROSS REFERENCE TO RELATED APPLICATIONS

This is a continuation application of PCT Patent Application No. PCT/JP2010/004081 filed on Jun. 18, 2010, designating the United States of America, which is based on and claims priority of Japanese Patent Application No. 2009-283354 filed on Dec. 14, 2009.

The entire disclosures of the above-identified applications, including the specifications, drawings and claims are incorporated herein by reference in their entirety.

### TECHNICAL FIELD

The present invention relates to image decoding apparatuses and image decoding methods, and in particular to an image decoding apparatus which decodes a first coded signal obtained by coding first image signals corresponding to a first viewpoint and a second coded signal obtained by coding second image signals corresponding to a second viewpoint.

### BACKGROUND ART

In recent years, there are growing expectations for a stereoscopic image system mainly using digital broadcasting and package media, as a high-definition image system. In general, it is known that people can perceive depth with parallax of both eyes. A stereoscopic image system utilizes this, and separately projects two images which have a disparity corresponding to this parallax, for left eyes and right eyes, thereby producing stereoscopic effects.

Various schemes have been proposed by now, as methods of separately giving images having a disparity to left eyes and right eyes. For example, a two-dimensional image for left eyes and a two-dimensional image for right eyes are alternately displayed on the same screen. Furthermore, glasses, for instance, which include liquid crystal shutters or the like are used, and a shutter for a left eye and a shutter for a right eye are switched in synchronization with the timing at which such images are displayed. This is a method of giving images having a disparity to viewers. It should be noted that it is necessary to give, to left eyes and right eyes, display frames, the number of which is the same as that of a two-dimensional image system, in order to produce a strong sense of realism.

In other words, in such a stereoscopic image system, it is necessary to simultaneously perform decoding processing on a plurality of bit streams for left eyes and for right eyes. Thus, compared with a two-dimensional-image system, a stereoscopic image system needs to have high capability for image decoding processing, which results in an increase in cost.

As a method for simultaneously decoding a plurality of bit streams while reducing such an increase in cost, Patent Literature (PTL) 1 discloses a technique for decoding a plurality of bit streams in parallel using a plurality of image decoding units.

FIG. 30 is a block diagram showing a configuration of an image decoding apparatus 500 described in PTL 1.

The image decoding apparatus 500 shown in FIG. 30 includes an input unit 502, a header analysis unit 503, and a decoding control unit 504. Furthermore, the image decoding apparatus 500 includes arithmetic decoding units 505, 506, and 507, storing units 508, 509, and 510, and image decoding units 511, 512, and 513 in parallel to one another, on a downstream side relative to the decoding control unit 504. Further, bit streams A, B, and C are input to the image decoding apparatus 500.

In response to the analysis result obtained by the header analysis unit 503, the decoding control unit 504 notifies the arithmetic decoding units 505, 506, and 507 of a timing at which the arithmetic decoding units 505, 506, and 507 are to start arithmetic decoding processing, a position in a bit stream at which arithmetic decoding processing is to be started, and the like.

The arithmetic decoding units 505, 506, and 507 are individually provided in one-to-one correspondence with bit streams A, B, and C which are input. The arithmetic decoding units 505, 506, and 507 perform arithmetic decoding processing on the respective bit streams A, B, and C concurrently, and output data generated as a result of the arithmetic decoding to the respective storing units 508, 509, and 510.

The image decoding units 511, 512, and 513 simultaneously reproduce a plurality of data streams by decoding the data obtained as a result of the arithmetic decoding and stored in the storing units 508, 509, and 510, into actual image data.

Further, PTL 2 discloses a method for simultaneously decoding a plurality of bit streams by performing time division processing using a single image decoding unit.

FIG. 31 is a block diagram showing a configuration of an image decoding apparatus 600 described in PTL 2.

The image decoding apparatus 600 shown in FIG. 31 includes a plurality of video buffer verifier (VBV) buffers 601, a variable length decoder 602, an inverse quantizer 603, and an inverse discrete cosine transformer 604, an adder 605, an image memory 606, a motion-compensation predictor 607, a demultiplexer 611, signal switchers 612, 613, and 614, a decoding controller 621, a display controller 622, and a switch controller 623.

In the image decoding apparatus 600, the variable length decoder 602, the inverse quantizer 603, the inverse discrete cosine transformer 604, the adder 605, and the motion-compensation predictor 607 are each composed of a single resource. Further, the image decoding apparatus 600 inputs a plurality of bit streams to these circuits using time division, and performs decoding processing.

Specifically, a transport stream in which image bit streams corresponding to a plurality of channels are multiplexed is input to the demultiplexer 611 on the upstream side. The demultiplexer 611 separates the transport stream into bit streams corresponding to the channels. The bit streams corresponding to the channels obtained as a result of the separation are respectively stored into the corresponding VBV buffers 601 (VBV buffers 1 to N).

After the demultiplexing processing, it is necessary to perform processing for simultaneously decoding N bit streams stored in the VBV buffers 1 to N. For this, a bit stream in one of the VBV buffers 601 each corresponding to a specific channel is selected by the signal switcher 612, based on a switch switching signal from the switch controller 623. This selected bit stream is input to the variable length decoder 602. After that, decoding processing is performed on this bit stream by the variable length decoder 602, the inverse quantizer 603, the inverse discrete cosine transformer 604, and the motion-compensation predictor 607. Image data obtained as a result of the decoding processing is input from the adder 605 to the signal switcher 613. The signal switcher 613 stores this image data into a memory for a corresponding channel among the image memories 606 (the image memories 1 to N), based on a switch switching signal output by the switch controller 623.

The display controller 622 performs control so that image data pieces corresponding to channels in the image memories 1 to N are simultaneously read and displayed at a predetermined display timing. Accordingly, the display controller 622 simultaneously reproduces a plurality of bit streams, achieving synchronization among channels.

### CITATION LIST

### Patent Literature

[PTL 1] Japanese Unexamined Patent Application Publication No. 2007-150569
[PTL 2] Japanese Unexamined Patent Application Publication No. 2000-165858

### SUMMARY OF INVENTION

### Technical Problem

In a stereoscopic image system, it is necessary to individually transmit and record an image for left eyes and an image for right eyes as separate images, in order to give a sense of realism to viewers, as described above. Therefore, such a stereoscopic image system needs information which is about twice as much as that for a single two-dimensional image system. This requires a wide transfer band for a transmission system, and in addition, a huge storage capacity for a storage system. This increases a cost of the system.

In view of this, an image coding scheme is now being devised in order to reduce the amount of data for realizing a stereoscopic image system. The H.264-multi view coding (MVC) standard utilizes the fact that videos from different viewpoints often have a correlation, and provides an inter-view prediction structure based on the H.264 standard as shown in FIG. 32. Thus, compression efficiency can be increased by eliminating redundancy.

A viewpoint ID represented by view_id is given to each viewpoint, and the viewpoints are managed as “views” and distinguished from one another. Such views include a base view to be referred to for other views, and non base views for which the base view is referred to. Specifically, non base views are coded using images in the base view as prediction images during inter-view prediction, thereby increasing the coding efficiency.

However, in a system in which data coded using such inter-view prediction is provided as an individual bit stream for each view, conventional technology has a problem regarding identification of images to be referred to for non base views when such bit streams are to be decoded.

Specifically, according to the H.264-MVC standard, reference to only an image in the base view decoded at the same time (in the same access unit) is permitted for non base views. Therefore, in syntax information in a bit stream, view_id of only a view (base view) to be referred to is designated for each non base view.

Specifically, when an image in a non base view is to be decoded, it is necessary to know, from view_id, a view (base view) to be referred to, and which image is an image to be referred to (which is an image in the same access unit) from among images in a frame memory in which resultant images after decoding in the base view are stored.

However, if a configuration is adopted in which decoding processing is independently performed on images corresponding to channels without taking into consideration decoding information of other channels as with the conventional technology, a problem arises that it is not possible to identify an image to be referred to for each channel, nor properly perform decoding processing.

The present invention has been conceived to solve such a problem, and an object thereof is to provide an image decoding apparatus capable of decoding a plurality of bit streams coded using inter-view prediction, and also identifying an image to be referred to for each channel.

### Solution to Problem

In order to achieve the above object, an image decoding apparatus according to an aspect of the present invention is an image decoding apparatus which decodes a first coded signal obtained by coding first image signals corresponding to a first viewpoint, and a second coded signal obtained by coding second image signals corresponding to a second viewpoint different from the first viewpoint, the apparatus including: an image decoding unit configured to decode the first coded signal and the second coded signal by referring to reference images, to generate first decoded image signals and second decoded image signals; and a frame memory for storing the first decoded image signals and the second decoded image signals as the reference images, wherein the image decoding unit is configured to decode the first coded signal by referring to one of the first decoded image signals as the reference image, and decode the second coded signal by referring to one of the first decoded image signals or one of the second decoded image signals as the reference image, the image decoding apparatus further including: a management information storage unit configured to store first management information for identifying areas in each of which one of the first decoded image signals is stored, and second management information for identifying areas in each of which one of the second decoded image signals is stored, the areas being included in the frame memory; and a control unit configured to notify, by referring to the first management information, the image decoding unit of an area in which a reference image to be referred to when the first coded signal is decoded is stored, and notify, by referring to the first management information and the second management information, the image decoding unit of an area in which a reference image to be referred to when the second coded signal is decoded is stored, the areas being included in the frame memory.

According to this configuration, the image decoding apparatus according to the aspect of the present invention can identify, using the first management information, the first decoded image signal to be referred to when the second coded signal is decoded. In this manner, the image decoding apparatus according to the aspect of the present invention can decode a plurality of bit streams coded using inter-view prediction, and also identify an image to be referred to for each channel.

Further, the first management information may include: a first syntax information list including, for each of the first decoded image signals, first syntax information included in the first coded signal and used for identifying the first decoded image signal, and a first identification number associated with the first syntax information; and a first mapping list showing, for each of the first decoded image signals, a correspondence between the first identification number and an area in the frame memory, the control unit may be configured to (i) obtain the first identification number corresponding to one of the first decoded image signals by referring to the first syntax information list, (ii) obtain an area included in the frame memory and corresponding to the obtained first identification number by referring to the first mapping list, and (iii) notify the image decoding unit of the obtained area in the frame memory, as an area which is included in the frame memory and in which a corresponding one of the reference images is stored, the second management information may include: a second syntax information list including, for each of the second decoded image signals, second syntax information included in the second coded signal and used for identifying the second decoded image signal, and a second identification number associated with the second syntax information; and a second mapping list showing, for each of the second decoded image signals, a correspondence between the second identification number and an area in the frame memory, and the control unit may be configured to (i) obtain the second identification number corresponding to one of the second decoded image signals by referring to the second syntax information list, (ii) obtain an area included in the frame memory and corresponding to the obtained second identification number by referring to the second mapping list, and (iii) notify the image decoding unit of the obtained area in the frame memory, as an area which is included in the frame memory and in which a corresponding one of the reference images is stored.

According to this configuration, the image decoding apparatus according to the aspect of the present invention can identify, using the first syntax information list and the first mapping list, a first decoded image signal to be referred to when the second coded signal is decoded.

Further, the first syntax information and the second syntax information may be syntax information necessary when a decoded picture buffer (DPB) defined by the H.264 standard is updated.

Further, the first syntax information list may include: a syntax information list for intra-view reference including the first syntax information and the first identification number, for each of the first decoded image signals to be referred to when the image decoding unit decodes the first coded signal; and a syntax information list for inter-view reference including the first syntax information and the first identification number, for each of the first decoded image signals to be referred to when the image decoding unit decodes the second coded signal, when the image decoding unit decodes the first coded signal, the control unit may be configured to (i) obtain the first identification number corresponding to one of the first decoded image signals by referring to the syntax information list for intra-view reference, (ii) obtain an area included in the frame memory and corresponding to the obtained first identification number by referring to the first mapping list, and (iii) notify the image decoding unit of the obtained area in the frame memory, as an area which is included in the frame memory and in which a corresponding one of the reference images is stored, and when the image decoding unit decodes the second coded signal, the control unit may be configured to (i) obtain the first identification number corresponding to one of the first decoded image signals by referring to the syntax information list for inter-view reference, (ii) obtain an area included in the frame memory and corresponding to the obtained first identification number by referring to the first mapping list, and (iii) notify the image decoding unit of the obtained area in the frame memory, as an area which is included in the frame memory and in which a corresponding one of the reference images is stored.

According to this configuration, the image decoding apparatus according to the aspect of the present invention can separately manage and control intra-view reference and inter-view reference by separately providing the syntax information list for intra-view reference used for intra-view reference, and the syntax information list for inter-view reference used for inter-view reference. Accordingly, the image decoding apparatus according to the aspect of the present invention can suitably manage and control images for inter-view reference.

Further, the first mapping list may include: a mapping list for intra-view reference showing a correspondence between the first identification number and an area in the frame memory, for each of the first decoded image signals to be referred to when the image decoding unit decodes the first coded signal; and a mapping list for inter-view reference showing a correspondence between the first identification number and an area in the frame memory, for each of the first decoded image signals to be referred to when the image decoding unit decodes the second coded signal, when the image decoding unit decodes the first coded signal, the control unit may be configured to (i) obtain the first identification number corresponding to one of the first decoded image signals by referring to the syntax information list for intra-view reference, (ii) obtain an area included in the frame memory and corresponding to the obtained first identification number by referring to the mapping list for intra-view reference, and (iii) notify the image decoding unit of the obtained area in the frame memory, as an area which is included in the frame memory and in which a corresponding one of the reference images is stored, and when the image decoding unit decodes the second coded signal, the control unit may be configured to (i) obtain the first identification number corresponding to one of the first decoded image signals by referring to the syntax information list for inter-view reference, (ii) obtain an area included in the frame memory and corresponding to the obtained first identification number by referring to the mapping list for inter-view reference, and (iii) notify the image decoding unit of the obtained area in the frame memory, as an area which is included in the frame memory and in which a corresponding one of the reference images is stored.

According to this configuration, the image decoding apparatus according to the aspect of the present invention can separately manage and control intra-view reference and inter-view reference by separately providing the mapping list for intra-view reference used for intra-view reference and the mapping list for inter-view reference used for inter-view reference. Accordingly, the image decoding apparatus according to the aspect of the present invention can suitably manage and control images for inter-view reference.

Further, the image decoding apparatus may further include an image display unit configured to output the first decoded image signals and the second decoded image signals stored in the frame memory to an outside, wherein the first mapping list may further include, for each of the first decoded image signals, first image display information indicating whether the first decoded image signal has been output to the outside by the image display unit, and first reference information indicating whether the first decoded image signal is to be used as the reference image, and when the first image display information corresponding to one of the first decoded image signals indicates that the first decoded image signal has been output to the outside, and the first reference information corresponding to the first decoded image signal indicates that the first decoded image signal is not to be used as the reference image, the control unit may be configured to store, into an area which is included in the frame memory and in which the first decoded image signal has been stored, a first decoded image signal newly decoded by the image decoding unit.

According to this configuration, the image decoding apparatus according to the aspect of the present invention can suitably manage a free area of the frame memory using the first mapping list.

Further, the image decoding unit may include: a first decoding unit configured to generate the first decoded image signals by decoding the first coded signal; and a second decoding unit configured to generate the second decoded image signals by decoding the second coded signal, and after both the first decoding unit and the second decoding unit complete decoding processing on the first coded signal and on the second coded signal, respectively, for a unit of decoding processing previously determined, the control unit may be configured to cause the first decoding unit and the second decoding unit to start decoding processing for the next unit of decoding processing.

According to this configuration, the image decoding apparatus according to the aspect of the present invention can achieve synchronization between decoding processing on the first coded signal and decoding processing on the second coded signal.

Further, the image decoding apparatus may further include a flag storage unit for storing a first completion flag and a second completion flag, wherein the control unit may include: a first control unit configured to control the first decoding unit, and store the first completion flag into the flag storage unit when decoding processing on the first coded signal for the unit of decoding processing by the first decoding unit is completed; and a second control unit configured to control the second decoding unit, and store the second completion flag into the flag storage unit when decoding processing on the second coded signal for the unit of decoding processing by the second decoding unit is completed, when decoding processing on the first coded signal for the unit of decoding processing by the first decoding unit is completed, and the second completion flag is stored in the flag storage unit, the first control unit may be configured to cause the first decoding unit to start decoding processing on the first coded signal for the next unit of decoding processing, and when decoding processing on the second coded signal for the unit of decoding processing by the second decoding unit is completed, and the first completion flag is stored in the flag storage unit, the second control unit may be configured to cause the second decoding unit to start decoding processing on the second coded signal for the next unit of decoding processing.

According to this configuration, the image decoding apparatus according to the aspect of the present invention can prevent control of decoding processing from being complicated, by separately controlling decoding processing on the first coded signal and decoding processing on the second coded signal.

Further, the image decoding unit may include: a selection unit configured to select one of the first coded signal and the second coded signal; and a decoding unit configured to decode the first coded signal or the second coded signal selected by the selection unit, and the control unit may be configured to (i) cause the selection unit to select one of the first coded signal and the second coded signal, and (ii) cause, after decoding processing on the selected signal for a unit of decoding processing previously determined is completed, the selection unit to select the other of the first coded signal and the second coded signal.

According to this configuration, the image decoding apparatus according to the aspect of the present invention can achieve synchronization between decoding processing on the first coded signal and decoding processing on the second coded signal.

Further, the image decoding apparatus may further include a flag storage unit for storing a first completion flag and a second completion flag, wherein the control unit may include: a first control unit configured to control the first decoding unit, and store the first completion flag into the flag storage unit when decoding processing on the first coded signal for the unit of decoding processing by the first decoding unit is completed; and a second control unit configured to control the second decoding unit, and store the second completion flag into the flag storage unit when decoding processing on the second coded signal for the unit of decoding processing by the second decoding unit is completed, when the second completion flag is stored in the flag storage unit, the first control unit may be configured to cause the decoding unit to start decoding processing on the first coded signal for the next unit of decoding processing, and when the first completion flag is stored in the flag storage unit, the second control unit may be configured to cause the decoding unit to start decoding processing on the second coded signal for the next unit of decoding processing.

According to this configuration, the image decoding apparatus according to the aspect of the present invention can prevent control of decoding processing from being complicated, by separately controlling decoding processing on the first coded signal and decoding processing on the second coded signal.

Further, the image decoding apparatus may further include a combining unit configured to generate a third coded signal by alternately arranging the first coded signal and the second coded signal each in a unit of coding previously determined, wherein the image decoding unit may be configured to alternately decode the first coded signal and the second coded signal included in the third coded signal for the unit of coding.

According to this configuration, the image decoding apparatus according to the aspect of the present invention can achieve synchronization between decoding processing on the first coded signal and decoding processing on the second coded signal.

Further, the unit of coding may be one of a frame unit, a field unit, and a slice unit.

Further, among the first coded signal and the second coded signal which correspond to each other and are each in the unit of coding, the combining unit may be configured to generate the third coded signal by arranging the first coded signal in the unit of coding, and thereafter arranging the second coded signal which is in the unit of coding and corresponds to the first coded signal.

According to this configuration, the image decoding apparatus according to the aspect of the present invention can always preferentially decode the first coded signal to be referred to during decoding processing on the second coded signal.

Further, the unit of decoding processing may be one of a frame unit, a field unit, a unit of header decoding processing, and a slice unit.

It should be noted that the present invention can be realized not only as such an image decoding apparatus, but also as an image decoding method in which distinguishing means included in the image decoding apparatus are used as steps, and also as a program for causing a computer to execute such distinguishing steps. In addition, it goes without saying that such a program can be distributed via a recording medium such as a CD-ROM and a transmission medium such as the Internet.

Furthermore, the present invention can be realized as a semiconductor integrated circuit (LSI) which realizes some or all of the functions of such an image decoding apparatus, as an image reproducing apparatus, for instance, including such an image decoding apparatus, and as an image display system including such an image decoding apparatus.

### Advantageous Effects of Invention

As described above, the present invention can provide an image decoding apparatus capable of decoding a plurality of bit streams coded using inter-view prediction, and also identifying an image to be referred to for each channel.

### BRIEF DESCRIPTION OF DRAWINGS

These and other objects, advantages and features of the invention will become apparent from the following description thereof taken in conjunction with the accompanying drawings that illustrate a specific embodiment of the present invention. In the Drawings.

FIG. 1 is a block diagram showing a configuration of an image decoding apparatus according to Embodiment 1 of the present invention;

FIG. 2 is a block diagram showing a configuration of the image decoding apparatus according to Embodiment 1 of the present invention;

FIG. 3 is a block diagram of an image decoding unit according to Embodiment 1 of the present invention;

FIG. 4 shows reference picture numbers according to Embodiment 1 of the present invention;

FIG. 5 shows a configuration of syntax information according to Embodiment 1 of the present invention;

FIG. 6 shows a configuration of a decoded picture buffer (DPB) list according to Embodiment 1 of the present invention;

FIG. 7 shows a configuration of a frame memory mapping list according to Embodiment 1 of the present invention;

FIG. 8 shows a correspondence between reference picture numbers and base addresses according to Embodiment 1;

FIG. 9 shows processing performed by control units according to Embodiment 1 of the present invention;

FIG. 10 shows an image display timing according to Embodiment 1 of the present invention;

FIG. 11 shows a stream structure according to Embodiment 1 of the present invention;

FIG. 12 is a flowchart showing decoding processing performed by the image decoding apparatus according to Embodiment 1 of the present invention;

FIG. 13 is a flowchart showing decoding processing performed by the image decoding apparatus according to Embodiment 1 of the present invention;

FIG. 14 shows a synchronization relationship between L side decoding processing and R side decoding processing according to Embodiment 1 of the present invention;

FIG. 15 shows an example of operation of the image decoding apparatus according to Embodiment 1 of the present invention;

FIG. 16 is a block diagram showing a configuration of an image decoding apparatus according to Embodiment 2 of the present invention;

FIG. 17 shows an image display timing according to Embodiment 2 of the present invention;

FIG. 18 shows a synchronization relationship between L side decoding processing and R side decoding processing according to Embodiment 2 of the present invention;

FIG. 19 shows an example of operation of the image decoding apparatus according to Embodiment 2 of the present invention;

FIG. 20 is a block diagram showing a configuration of an image decoding apparatus according to Embodiment 3 of the present invention;

FIG. 21 shows a configuration of a frame memory mapping list according to Embodiment 3 of the present invention;

FIG. 22 shows an example of operation of the image decoding apparatus according to Embodiment 3 of the present invention;

FIG. 23 is a block diagram showing a configuration of an image decoding apparatus according to Embodiment 4 of the present invention;

FIG. 24 is a block diagram showing a configuration of an image decoding apparatus according to Embodiment 5 of the present invention;

FIG. 25 is a block diagram showing a configuration of an image decoding apparatus according to Embodiment 6 of the present invention;

FIG. 26 shows processing performed by a control unit according to Embodiment 6 of the present invention;

FIG. 27 is a flowchart showing decoding processing performed by the image decoding apparatus according to Embodiment 6 of the present invention;

FIG. 28 is a flowchart showing decoding processing performed by the image decoding apparatus according to Embodiment 6 of the present invention;

FIG. 29 is a block diagram showing a configuration of an image decoding apparatus according to Embodiment 7 of the present invention;

FIG. 30 is a block diagram showing a configuration of an image decoding apparatus according to conventional technology;

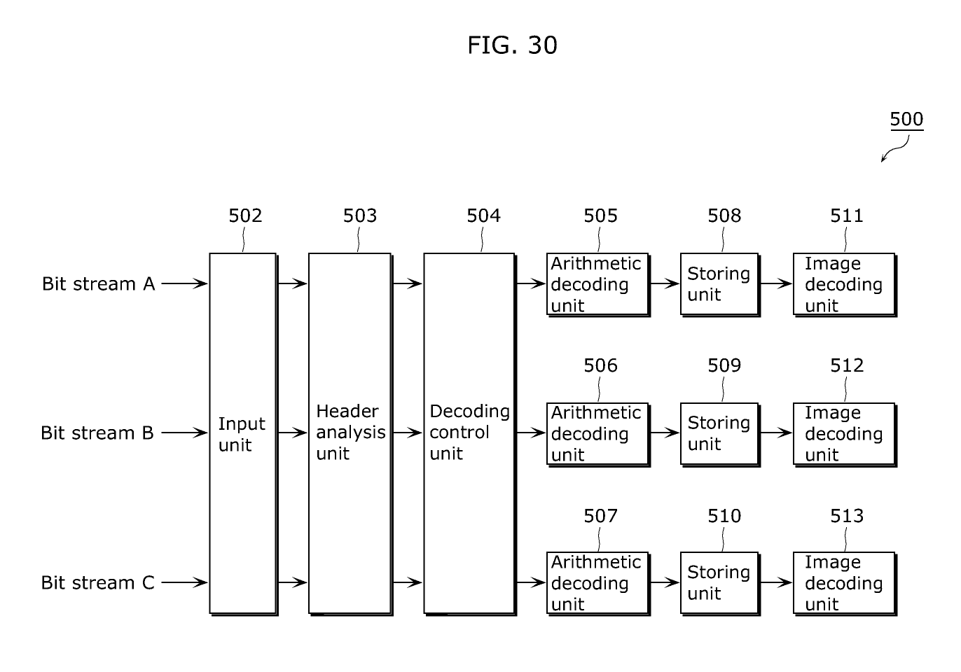

FIG. 31 is a block diagram showing a configuration of an image decoding apparatus according to conventional technology; and

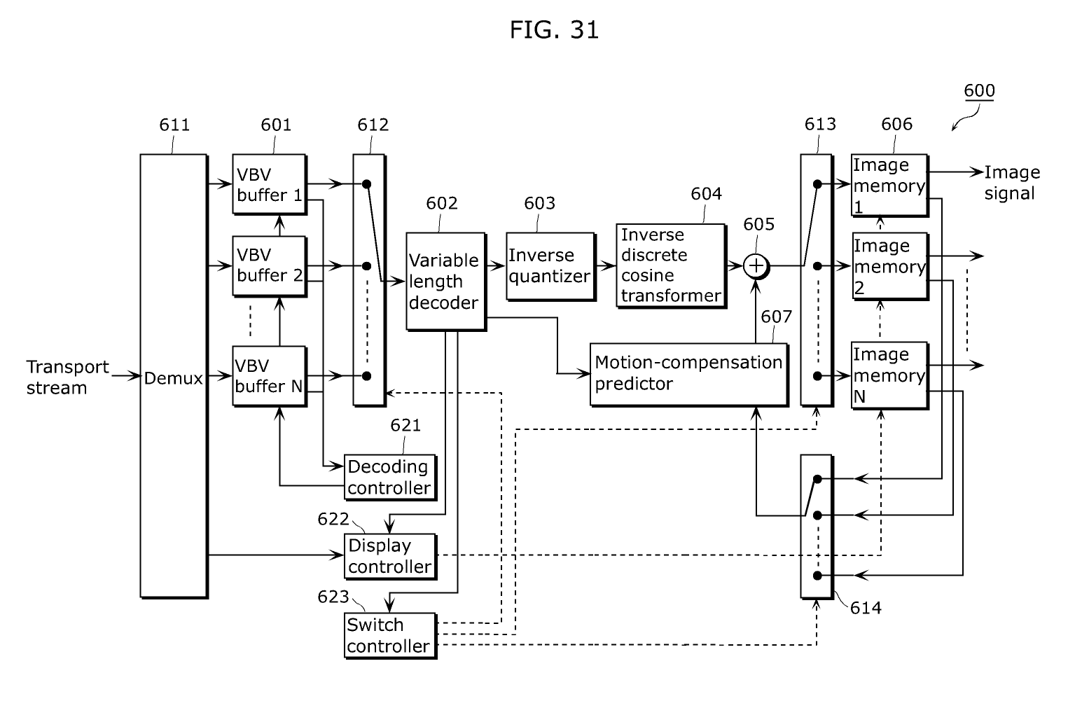

FIG. 32 shows a reference relationship according to the H.264-MVC standard.

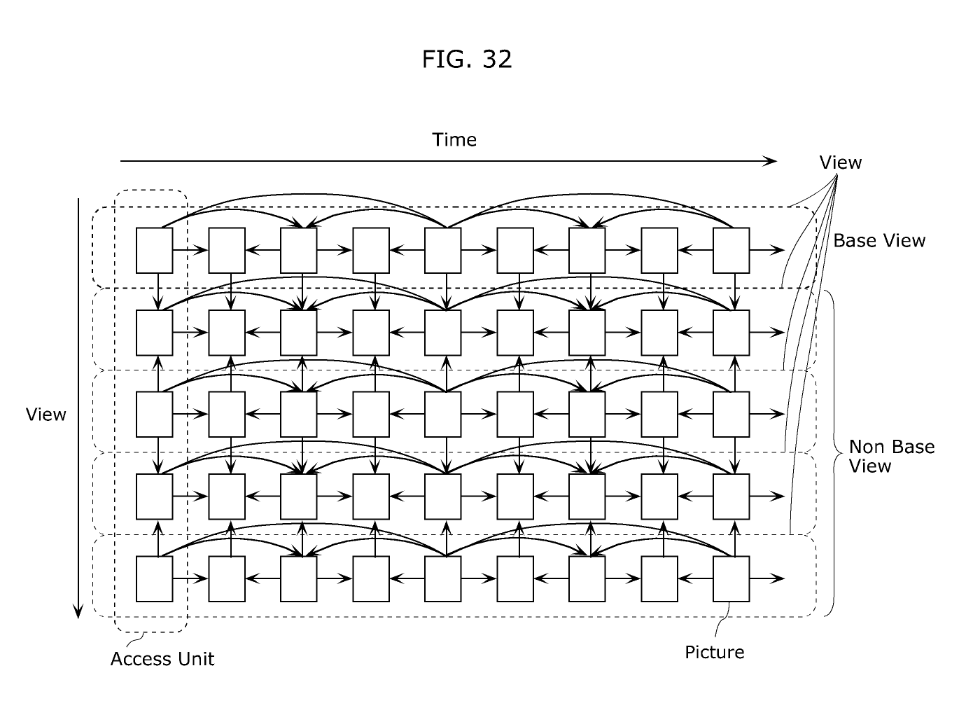

### DESCRIPTION OF EMBODIMENTS

The following is a detailed description of embodiments of an image decoding apparatus according to the present invention, with reference to drawings.

### Embodiment 1

An image decoding apparatus according to Embodiment 1 of the present invention identifies an area in which a reference image to be referred to when decoding a second bit stream is stored, using first management information for identifying an area in which a first decoded image signal obtained by decoding a first coded bit stream is stored. Accordingly, the image decoding apparatus according to Embodiment 1 of the present invention can decode a plurality of bit streams coded using inter-view prediction, and furthermore can identify images to be referred to for channels.

First is a description of the configuration of an image decoding apparatus 100 according to the embodiment of the present invention.

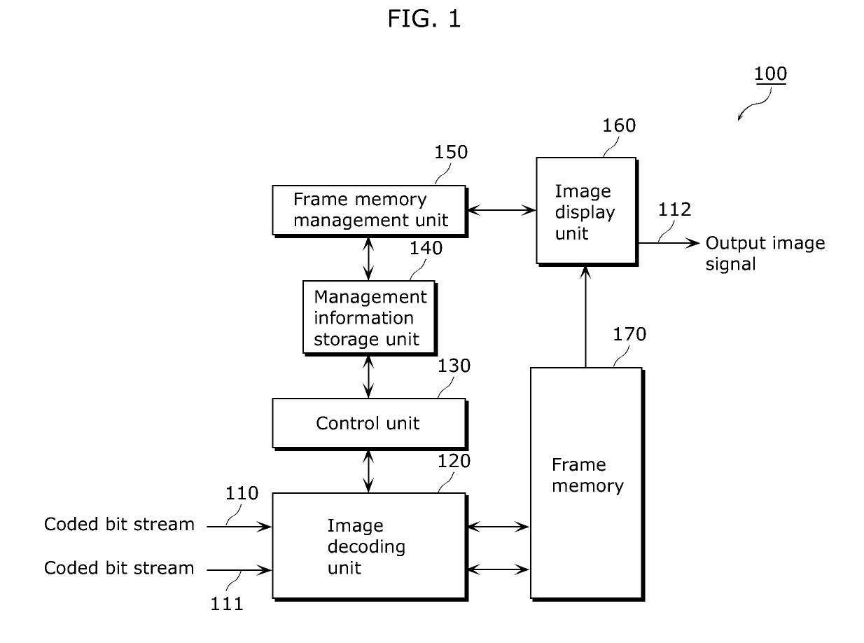

FIG. 1 is a block diagram showing a configuration of the image decoding apparatus 100 according to Embodiment 1 of the present invention.

The image decoding apparatus 100 shown in FIG. 1 generates an output image signal 112 by decoding a coded bit stream 110 and a coded bit stream 111.

The coded bit streams 110 and 111 are stream data pieces which include data obtained by coding images having a disparity therebetween. In other words, the coded bit stream 110 is a first coded signal obtained by coding first image signals captured from a first viewpoint. Further, the coded bit stream 111 is a second coded signal obtained by coding second image signals captured from a second viewpoint different from the first viewpoint.

It should be noted that the present embodiment describes decoding processing on bit streams coded in accordance with the H.264 standard, as an example. For example, the coded bit streams 110 and 111 are coded in conformity with the H.264-MVC standard. The coded bit stream 110 is a bit stream for left eyes (L side). The coded bit stream 111 is a bit stream for right eyes (R side). The coded bit streams 110 (L side) and 111 (R side) are input to the image decoding apparatus 100 as two separate coded bit streams.

It is assumed that the L side coded bit stream 110 corresponds to a base view, and the R side coded bit stream 111 corresponds to a non base view.

The image decoding apparatus 100 includes an image decoding unit 120, a control unit 130, a management information storage unit 140, a frame memory management unit 150, an image display unit 160, and a frame memory 170.

The image decoding unit 120 generates first decoded image signals (hereinafter, L side decoded pictures) and second decoded image signals (hereinafter, R side decoded pictures) by decoding the coded bit stream 110 and the coded bit stream 111 by referring to reference images. It should be noted that when the L side decoded pictures and the R side decoded pictures are not particularly distinguished, such pictures are also simply described as “decoded pictures”.

The frame memory 170 stores resultant image data after decoding (the L side decoded pictures and the R side decoded pictures) generated by the image decoding unit 120.

Since the coded bit stream 110 corresponds to a base view, the image decoding unit 120 decodes the coded bit stream 110 by referring to only the L side decoded pictures as reference images. Further, since the coded bit stream 111 corresponds to a non base view, the image decoding unit 120 decodes the coded bit stream 111 by referring to the L side decoded pictures and the R side decoded pictures as reference images.

It should be noted that in the following, inter-view reference indicates that a picture in the base view is referred to for a picture in a non base view. Further, intra-view reference indicates that a picture in a view is referred to for a picture in the same view (the base view or a non base view).

The control unit 130 controls decoding processing on the coded bit streams 110 and 111 performed by the image decoding unit 120.

The management information storage unit 140 stores picture management information used for decoding processing performed by the image decoding unit 120. This picture management information is information for identifying areas (base addresses) in the frame memory 170 in which the L side decoded pictures and the R side decoded pictures are stored. Further, this picture management information includes L side management information for identifying base addresses at which the L side decoded pictures are stored and R side management information for identifying base addresses at which the R side decoded pictures are stored.

The control unit 130 notifies the image decoding unit 120 of a base address at which a reference image to be referred to when the coded bit stream 110 is decoded is stored, by referring to the L side management information. Further, the control unit 130 notifies the image decoding unit 120 of a base address at which a reference image to be referred to when the coded bit stream 111 is decoded is stored, by referring to the L side management information and the R side management information.

The frame memory management unit 150 manages the frame memory 170.

The image display unit 160 generates the output image signal 112 including the L side decoded pictures and the R side decoded pictures stored in the frame memory 170, and outputs the generated output image signal 112 outside.

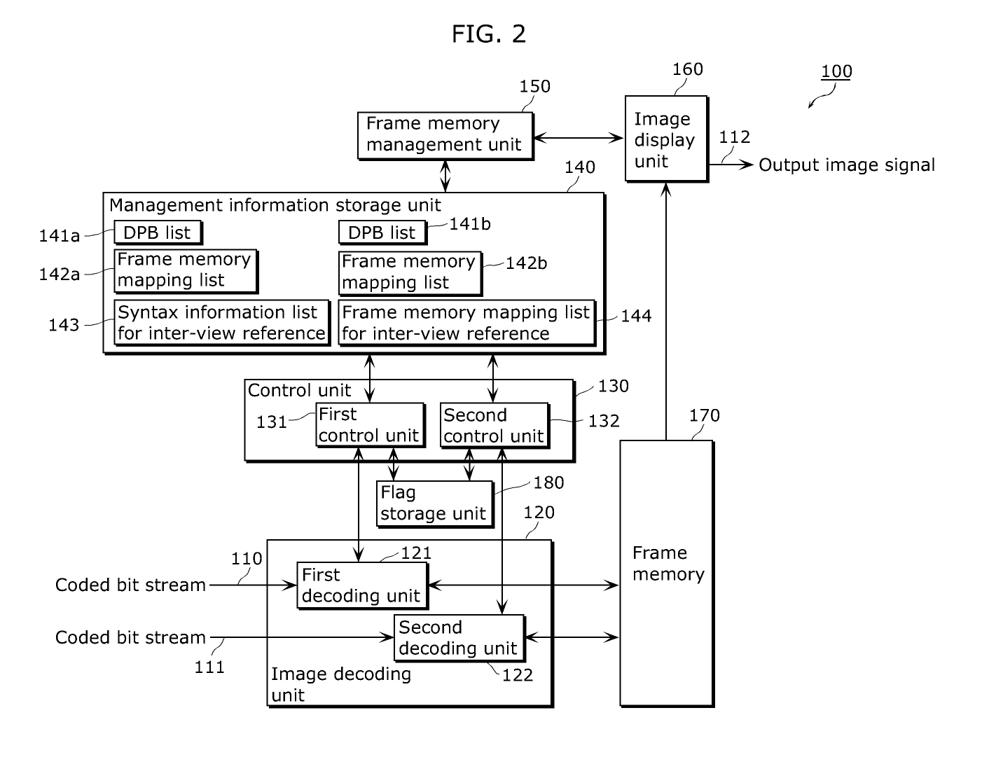

FIG. 2 is a block diagram showing a detailed configuration of the image decoding apparatus 100.

As shown in FIG. 2, the image decoding unit 120 includes a first decoding unit 121 and a second decoding unit 122.

The first decoding unit 121 generates L side decoded pictures by decoding the coded bit stream 110 in real time.

The second decoding unit 122 generates R side decoded pictures by decoding the coded bit stream 111 in real time.

The management information storage unit 140 stores therein, as picture management information, decoded picture buffer (DPB) lists 141a and 141b, frame memory mapping lists 142a and 142b, a syntax information list 143 for inter-view reference, and a frame memory mapping list 144 for inter-view reference. Here, the DPB list 141a, the frame memory mapping list 142a, the syntax information list 143 for inter-view reference, and the frame memory mapping list 144 for inter-view reference are the L side management information for identifying base addresses at which the L side decoded pictures are stored. Further, the DPB list 141b and the frame memory mapping list 142b are the R side management information for identifying base addresses at which the R side decoded pictures are stored.

The DPB list 141a includes syntax information for intra-view reference of the L side decoded pictures generated from the coded bit stream 110. Further, the DPB list 141b includes syntax information for intra-view reference of the L side decoded pictures generated from the coded bit stream 111. Here, syntax information includes parameters (variables) determined in accordance with the standard.

The syntax information list 143 for inter-view reference includes syntax information for inter-view reference.

The frame memory mapping lists 142a and 142b are used to manage base addresses in the frame memory 170.

The frame memory mapping list 144 for inter-view reference is used to manage base addresses of pictures for inter-view reference.

The frame memory management unit 150 manages base addresses in the frame memory 170 by updating the frame memory mapping lists 142a and 142b, based on information obtained from the control unit 130 and the image display unit 160.

The control unit 130 includes a first control unit 131 and a second control unit 132.

The first control unit 131 is in charge of decoding processing on the L side coded bit stream 110. The second control unit 132 is in charge of decoding processing on the R side coded bit stream 111.

The first control unit 131 controls decoding processing performed by the first decoding unit 121, using the DPB list 141a, the syntax information list 143 for inter-view reference, the frame memory mapping list 142a, and the frame memory mapping list 144 for inter-view reference which are stored in the management information storage unit 140.

The second control unit 132 controls decoding processing performed by the second decoding unit 122, using the DPB list 141b, the syntax information list 143 for inter-view reference, the frame memory mapping list 142b, and the frame memory mapping list 144 for inter-view reference which are stored in the management information storage unit 140.

Thus, the syntax information list 143 for inter-view reference and the frame memory mapping list 144 for inter-view reference can be accessed from both the first control unit 131 and the second control unit 132.

Furthermore, the image decoding apparatus 100 includes a flag storage unit 180.

The flag storage unit 180 stores a first completion flag and a second completion flag which are used by the first control unit 131 and the second control unit 132.

The first control unit 131 stores the first completion flag in the flag storage unit 180 when decoding processing on one picture is completed. The second control unit 132 stores the second completion flag in the flag storage unit 180 when decoding processing on one picture is completed. The flag storage unit 180 can be accessed from both the first control unit 131 and the second control unit 132. Therefore, the first control unit 131 and the second control unit 132 can check, via the flag storage unit 180, that each other's decoding processing has been completed.

The image display unit 160 obtains, from the frame memory management unit 150, a base address at which a picture to be displayed is stored among decoded pictures stored in the frame memory 170. The image display unit 160 reads the display target picture stored at the obtained base address from the frame memory 170, and outputs and displays the display target picture. Further, the image display unit 160 notifies the frame memory management unit 150 of the completion of the display.

The following is a description of configurations of the first decoding unit 121 and the second decoding unit 122.

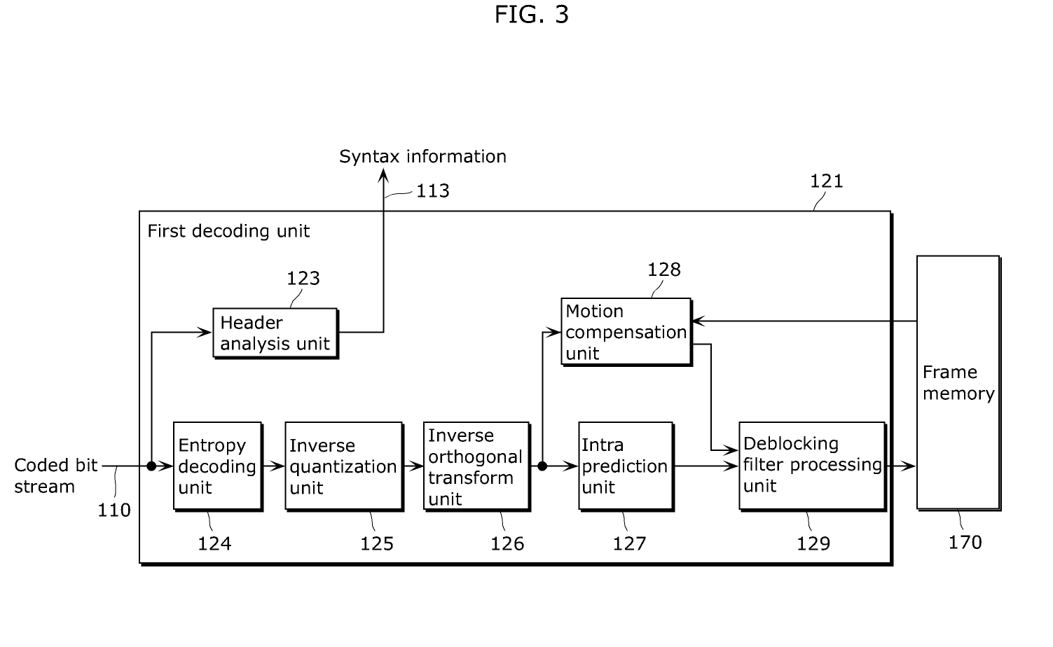

FIG. 3 is a block diagram showing a configuration of the first decoding unit 121. It should be noted that the configuration of the second decoding unit 122 is the same as that of the first decoding unit 121.

As shown in FIG. 3, the first decoding unit 121 includes a header analysis unit 123, an entropy decoding unit 124, an inverse quantization unit 125, an inverse orthogonal transform unit 126, an intra prediction unit 127, a motion compensation unit 128, and a deblocking filter processing unit 129.

The header analysis unit 123 analyzes a header into a sequence layer, a picture layer, a slice layer, and the like. Further, the header analysis unit 123 obtains syntax information 113 of an image to be decoded, which is included in the coded bit stream 110.

The first decoding unit 121 has a function of decoding a layer including macroblocks or smaller blocks. Specifically, a series of decoding processes in conformity with the H.264 standard is performed by the entropy decoding unit 124, the inverse quantization unit 125, the inverse orthogonal transform unit 126, the intra prediction unit 127, the motion compensation unit 128, and the deblocking filter processing unit 129.

It should be noted that the motion compensation unit 128 makes reference by reading a previously decoded image from the frame memory 170, and stores a resultant image after decoding into the frame memory 170.

Further, when reading from and writing to the frame memory 170 is to be performed, the first control unit 131 obtains a base address from the frame memory management unit 150, and sets the obtained address in the first decoding unit 121. Further, the second control unit 132 obtains a base address from the frame memory management unit 150, and sets the obtained address in the second decoding unit 122.

In order to facilitate a description of specific operation of the image decoding apparatus 100 having a configuration as described above, a description is given of a correspondence between terms defined by the H.264 standard and constituent elements of the present embodiment.

First is a description of a relationship between a decoded picture buffer (DPB) defined by the H.264 standard and the DPB lists 141a and 141b which are constituent elements of the present embodiment.

According to the H.264 standard, a plurality of decoded pictures can be used as reference pictures. Further, according to the H.264 standard, a different picture is selected for each motion compensation block, from among a plurality of reference pictures, and motion compensation processing is performed. An identification number assigned to each decoded picture to designate such a reference picture is referred to as a reference picture number (ref_idx). According to the H.264 standard, a reference picture number (ref_idx) is assigned for each motion compensation block when coding is performed, and a reference picture is identified using this reference picture number (ref_idx) when decoding is performed.

Here, although coding efficiency will increase if the number of reference pictures is increased, it is necessary to save many decoded pictures in a memory. In addition to such a plurality of reference pictures, it is also necessary to save, in a memory, non-reference pictures which are decoded pictures not to be referred to during motion compensation, until the display time therefor. Consequently, extremely large memory capacity will be necessary. Furthermore, management of these pictures will be complicated.

In view of this, according to the H.264 standard, a memory referred to as a decoded picture buffer (DPB) is prepared conceptually, and decoded pictures are stored into this DPB. Further, overall management of pictures is performed using a method such as sliding window or memory management control operation (MMCO). Consequently, a memory can be efficiently utilized, according to the H. 264 standard.

With sliding window or MMCO, processing is performed using the syntax information 113 of pictures.

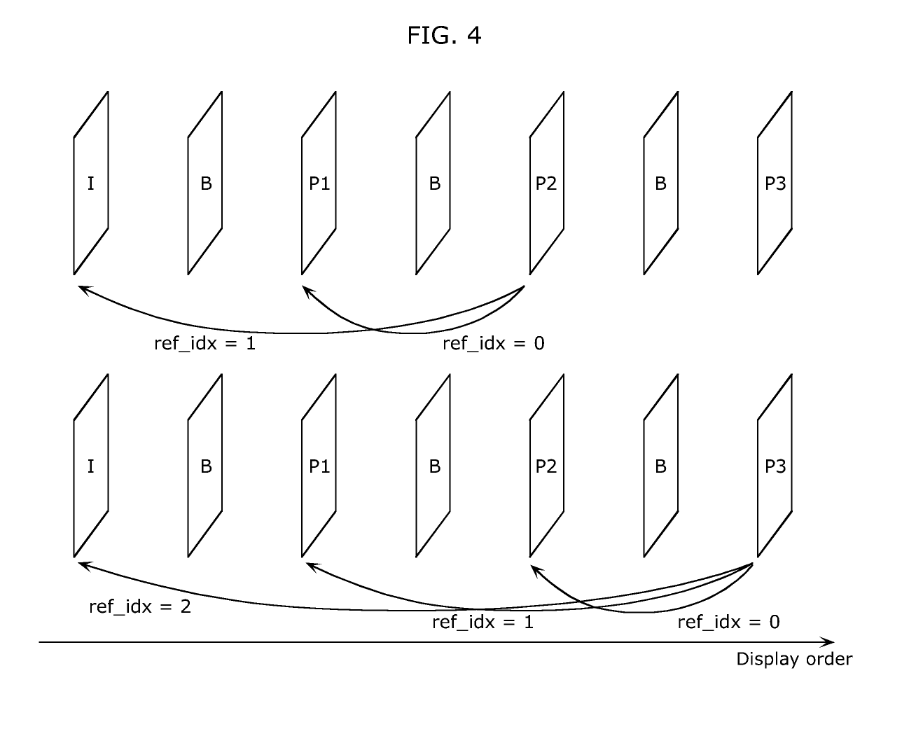

FIG. 4 shows a reference relationship among pictures.

Although a reference picture number (ref_idx) is assigned to designate a reference picture as described above, the assignment of a reference picture corresponding to a reference picture number can be changed for each picture to be decoded, as shown in FIG. 4. Further, a list referred to as a reference picture list (RPL) is used to associate reference pictures saved in the DPB with the reference picture numbers.

It should be noted that this RPL is created based on the syntax information 113 for each picture.

In the present embodiment, to adopt such a flexible reference structure according to the H.264 standard, the DPB lists 141a and 141b are stored in the management information storage unit 140, and pictures to be stored in the decoded picture buffer (DPB) specified by the H.264 standard are identified and managed using information in the DPB lists 141a and 141b, as described above.

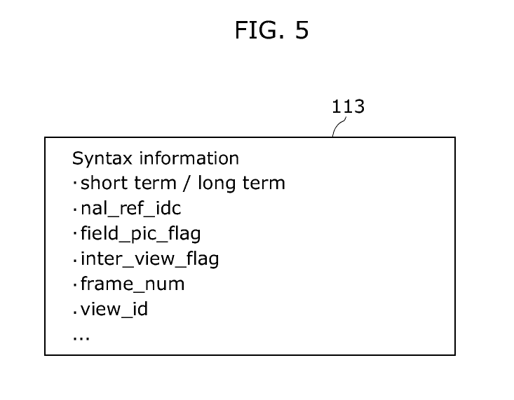

FIG. 5 shows a configuration of the syntax information 113 of each picture. The syntax information 113 is used to identify a decoded picture to be used as a reference picture.

As shown in FIG. 5, the syntax information 113 includes short term/long term, nal_ref_idc, field_pic_flag, inter_view_flag, frame_num, and view_id, for example. It should be noted that the syntax information 113 may include only some of the information pieces, or may include information other than these.

Whether a corresponding picture is a short term reference picture or a long term reference picture is indicated by “short term/long term”. A “short term reference picture” is a picture that can be managed using sliding window, and a “long term reference picture” is a picture that is located at a temporally distant position, and cannot be managed using sliding window.

Whether the picture is used as an intra-view reference is indicated by “nal_ref_idc”.

Whether the scheme for the picture uses (interlaced) fields or (progressive) frames is indicated by “field_pic_flag”.

Whether the picture is used as an inter-view reference is indicated by “inter_view_flag”.

The number of the picture is indicated by “frame_num”.

An identifier of a view including the picture is indicated by “view_id”. For example, “0” is given to a picture included in a base view, and “1, 2, and so on” are given to pictures included in non base views.

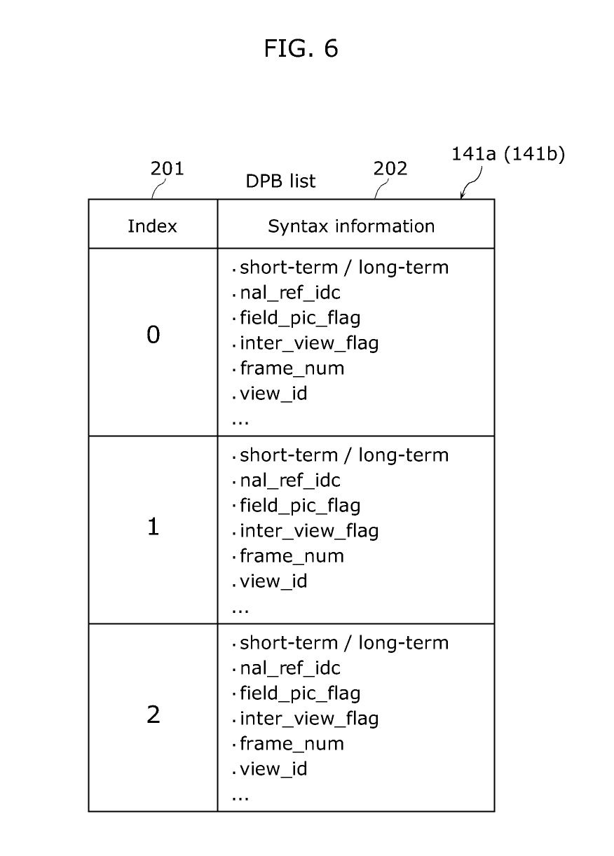

FIG. 6 shows a configuration of the DPB list 141a (141b).

The DPB lists 141a and 141b include the syntax information 113 of decoded pictures to be used as reference images for intra-view reference.

As shown in FIG. 6, syntax information 202 and an index 201 that is an identification number associated with the syntax information 202 are included for each decoded picture. This syntax information 202 corresponds to the syntax information 113 shown in FIG. 5.

Further, the number of the syntax information pieces 202 included in the DPB lists 141a and 141b is determined based on the number of reference pictures that can be used as intra-view references for pictures.

Also, the DPB lists 141a and 141b are used not only when decoding processing is performed on a macroblock layer, but also when the decoded picture buffer (DPB) specified by the H.264 standard is updated, and when the reference picture list (RPL) specified by the H.264 standard as well is created.

The syntax information list 143 for inter-view reference includes the syntax information 113 of decoded pictures to be used as reference images for inter-view reference. For example, the configuration of the syntax information list 143 for inter-view reference is the same as that in FIG. 6.

Also, the number of the syntax information pieces 202 included in the syntax information list 143 for inter-view reference is determined based on the number of reference pictures that can be used as inter-view references for pictures.

Next is a description of a relationship between the decoded picture buffer (DPB) defined by the H.264 standard and the frame memory mapping lists 142a and 142b which are constituent elements of the present embodiment.

According to the H.264 standard, a picture to be referred to is always stored into the decoded picture buffer (DPB). Further, each time decoding processing on one picture is completed, the content of the decoded picture buffer is updated.

The procedure of updating the decoded picture buffer (DPB) is also specified by the H.264 standard, and updating is performed following the procedure below.

(Step 1) Decode a picture.
(Step 2) Update a decoded picture buffer (DPB) using a predetermined rule (sliding window or MMCO), and determine a picture to be released.
(Step 3) Store the decoded picture obtained in Step 1 into the decoded picture buffer (DPB), instead of the release target picture in Step 2.

As described above, according to the standard, a picture for which decoding is completed in Step 1 is once saved in a temporary buffer until a picture to be released is determined in Step 2. Then, the picture for which decoding is completed is actually stored into the decoded picture buffer (DPB) in Step 3. Because of such a procedure, a temporary buffer that can store pictures being decoded needs to be additionally reserved in the implementation, apart from the memory capacity for the decoded picture buffer (DPB).

In the present embodiment, the frame memory 170 is also used as such a temporary buffer. Specifically, decode target pictures (pictures which are being decoded) are stored into the frame memory 170.

Thus, the frame memory 170 has both a picture specified by the H.264 standard (a picture in the DPB) and a picture dependent on the implementation configuration (a picture which is being decoded). Further, a frame memory area where a picture for which display is completed among these pictures has been stored is freed for storing a next picture. Therefore, it is necessary to collectively manage these pictures.

In the present embodiment, the frame memory mapping lists 142a and 142b are stored in the management information storage unit 140 as described above, to flexibly allow such management. Further, the state of each frame memory area in the frame memory 170 is managed, such as whether a picture in the area is designated as a reference picture in the DPB lists 141a and 141b, and whether a picture in the area is designated as an image to be displayed. This enables identification of a frame memory area to be freed for storing a next picture.

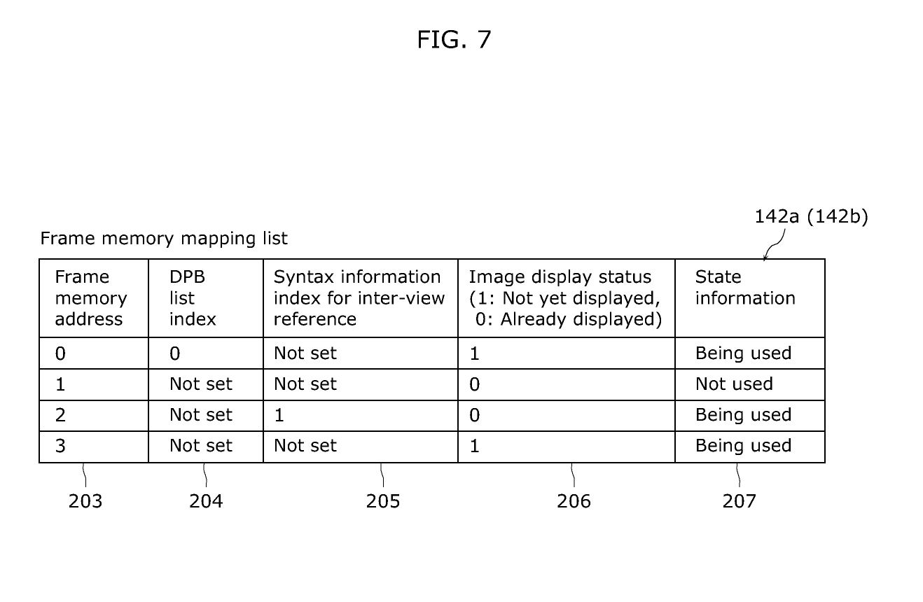

FIG. 7 shows a configuration of the frame memory mapping list 142a. For example, the frame memory mapping list 142a is in a table format as shown in FIG. 7. It should be noted that the configuration of the frame memory mapping list 142b is the same as that in FIG. 7.

As shown in FIG. 7, the frame memory mapping list 142a includes a plurality of entries each associated with a decoded picture. It should be noted that in the frame memory mapping list 142a, each entry corresponds to either one of a decoded picture used as a reference picture for intra-view reference, a decoded picture used as a reference picture for inter-view reference, and a picture which is not used as a reference picture and is being or has been decoded. Further, in the frame memory mapping list 142b, each entry corresponds to either a decoded picture used as a reference picture for intra-view reference or a picture which is not used as a reference picture and is being or has been decoded.

Each entry includes a frame memory address 203, a DPB list index 204, a syntax information index 205 for inter-view reference, an image display status 206, and state information 207.

The frame memory address 203 shows a base address in the frame memory 170 at which a corresponding decoded picture is stored.

The DPB list index 204 shows the index 201 in the DPB list 141a corresponding to the decoded picture. Also, the DPB list index 204 shows whether the decoded picture is to be used as a reference picture for intra-view reference. Specifically, when the index 201 in the DPB list 141a is set in the DPB list index 204, it is shown that the decoded picture is to be used as a reference picture for intra-view reference. Further, when the index 201 in the DPB list 141a is not set in the DPB list index 204 (in the case of “not set” in FIG. 7), it is shown that the decoded picture is not to be used as a reference picture for intra-view reference.

The syntax information index 205 for inter-view reference shows the index 201 in the syntax information list 143 for inter-view reference corresponding to the decoded picture. Further, the syntax information index 205 for inter-view reference shows whether the decoded picture is to be used as a reference picture for inter-view reference. Specifically, when the index 201 in the syntax information list 143 for inter-view reference is set in the syntax information index 205 for inter-view reference, it is shown that the decoded picture is to be used as a reference picture for inter-view reference. Further, when the index 201 in the syntax information list 143 for inter-view reference is not set in the syntax information index 205 for inter-view reference (in the case of “not set” in FIG. 7), it is shown that the decoded picture is not to be used as a reference picture for inter-view reference.

The image display status 206 shows whether the decoded picture has already been displayed (has already been output as the output image signal 112) or has not been displayed (not displayed).

The state information 207 shows whether a corresponding entry is being used or is not used. Specifically, if both the DPB list index 204 and the syntax information index 205 for inter-view reference show “not set”, and furthermore the image display status 206 shows “0” indicating “already displayed”, the state information 207 shows “not used”, and in other cases, the state information 207 shows “being used”.

The control unit 130 notifies the image decoding unit 120 to cause a picture newly decoded by the image decoding unit 120 to be stored at a base address for which “not used” is indicated by the state information 207.

In the example shown in FIG. 7, the entry for which the frame memory address 203 indicates “0” is used as a decoded picture buffer (DPB), and a corresponding index 201 given in the DPB list 141a is assigned thereto. Further, the entry for which the frame memory address 203 indicates “2” stores a picture for inter-view reference, and a corresponding index 201 given in the syntax information list 143 for inter-view reference is assigned. Further, the entry for which the frame memory address 203 indicates “3” is used as a temporary buffer (a picture which has not been displayed is stored), and thus cannot be used. Therefore, in this example, it can be determined that the entry for which the frame memory address 203 indicates “1” is not used, the entry not being used as a decoded picture buffer (DPB) nor being used as a temporary buffer.

It should be noted that in the present embodiment, when decoding a macroblock layer, the first decoding unit 121 or the second decoding unit 122 creates a reference picture list (RPL) defined by the H.264 standard, based on the syntax information 113 of each reference picture obtained from the coded bit stream 110, and content of the DPB list 141a or 141b given from the first control unit 131 or the second control unit 132, and holds therein the created RPL.

It should be noted that the configuration of the frame memory mapping list 144 for inter-view reference is the same as that in FIG. 7. In the frame memory mapping list 144 for inter-view reference, each entry corresponds to a decoded picture used as a reference picture for inter-view reference.

The frame memory mapping list 144 for inter-view reference is referred to only during inter-view reference, and thus may only include the frame memory address 203 and the syntax information index 205 for inter-view reference.

Further, if an R side decoded picture is not to be used as a reference image for inter-view reference, the frame memory mapping list 142b does not need to include the syntax information index 205 for inter-view reference.

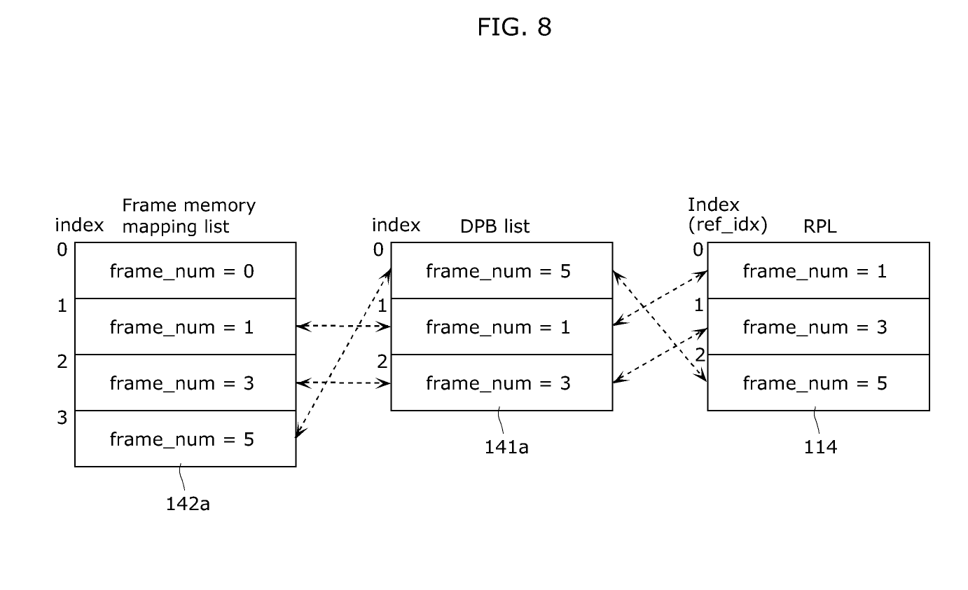

As described above, by associating the decoded picture buffer (DPB) and a reference picture list (RPL) 114 which are defined by the H.264 standard with constituent elements of the present embodiment, a base address in the frame memory 170 can be identified for each motion compensation block, based on the reference picture number (ref_idx) obtained from the coded bit stream 110, as in FIG. 8.

Specifically, the first control unit 131 obtains, for each motion compensation block, a reference picture number (ref_idx) obtained from the coded bit stream 110. Next, the first control unit 131 identifies a picture number corresponding to the reference picture number (ref_idx) by referring to the RPL 114. Next, the first control unit 131 identifies the index 201 of the syntax information 202 corresponding to the identified picture number, by referring to the DPB list 141a. Next, the first control unit 131 identifies a base address (the frame memory address 203) corresponding to the identified index 201, by referring to the frame memory mapping list 142a.

Further, the second control unit 132 obtains, for each motion compensation block, a reference picture number (ref_idx) obtained from the coded bit stream 110. Next, the second control unit 132 identifies a picture number corresponding to the reference picture number (ref_idx), by referring to the RPL 114. Next, the second control unit 132 identifies the index 201 of the syntax information 202 corresponding to the identified picture number, by referring to the DPB list 141b and the syntax information list 143 for inter-view reference. Next, the second control unit 132 identifies a base address (the frame memory address 203) corresponding to the identified index 201, by referring to the frame memory mapping list 142b and the frame memory mapping list 144 for inter-view reference.

Now, H.264-MVC is obtained as a multiview coding scheme by expanding H.264 having a flexible structure as described above. Specifically, H.264-MVC is a technique for realizing high information compression, by performing coding using viewpoints as views, and inter-view reference utilizing a correlation between the viewpoints.

Views are identified from one another based on view IDs (view_ids), and a view for which other views are not referred to is called a base view, whereas a view for which other views are referred to is called a non base view. For each picture in a non base view, a picture which is in a different view and captured at the same time can be referred to, in addition to pictures in the same view, which is a distinctive feature.

In the present embodiment, the L side coded bit stream 110 corresponds to a base view, and the R side coded bit stream 111 corresponds to a non base view. Specifically, when the R side coded bit stream 111 is decoded, decoded pictures in the L side coded bit stream 110 can be used as inter-view references.

The syntax information list 143 for inter-view reference has stored therein the syntax information 113 of reference pictures in the L side coded bit stream 111 which corresponds to a base view.

When the R side coded bit stream 111 which corresponds to a non base view is to be decoded, the second control unit 132 obtains the syntax information list 143 for inter-view reference including the syntax information 113 for inter-view reference, in addition to the DPB list 141b including the syntax information 113 for intra-view reference. Based on these, the second decoding unit 122 creates an RPL including inter-view reference pictures.

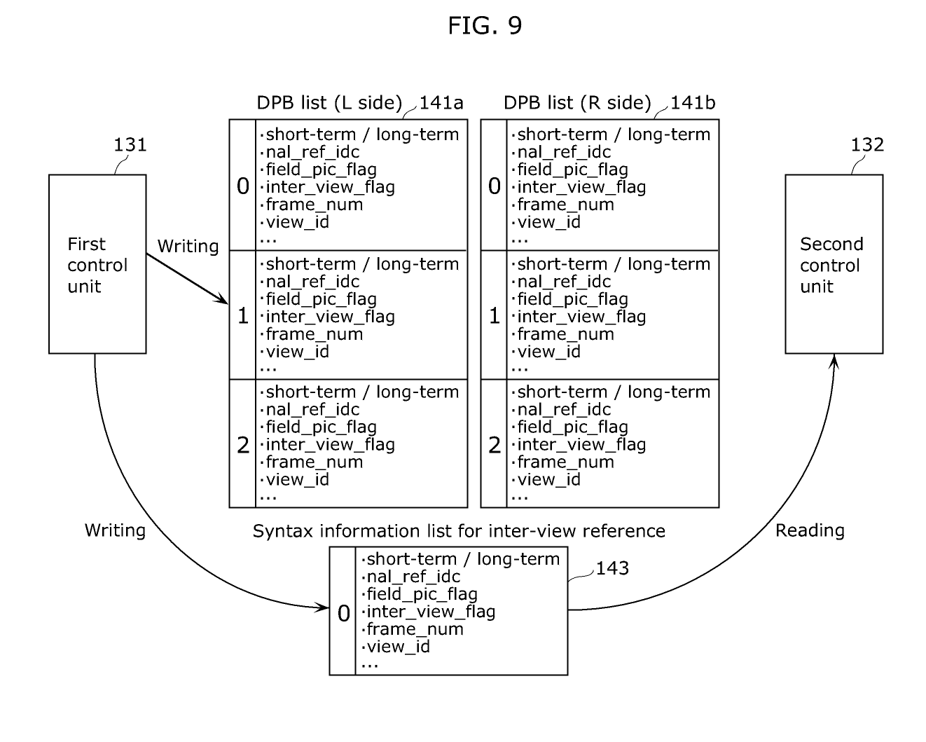

FIG. 9 shows processing performed by the first control unit 131 and the second control unit 132.

Specifically, the first control unit 131 also stores information stored in a portion having the index number “1” in the L side DPB list 141a into the syntax information list 143 for inter-view reference which can be referred to from the R side, as in the example of FIG. 9.

Accordingly, the frame memory management unit 150 manages the state of each frame memory area in the frame memory 170, such as whether a picture in the area is designated as a reference picture in the DPB lists 141a and 141b, and whether a picture in the area is designated as an image to be displayed. Furthermore, the frame memory management unit 150 manages a state such as whether a picture is designated in the syntax information list 143 for inter-view reference as a reference picture used for inter-view reference. Accordingly, the frame memory management unit 150 can identify an area in the frame memory 170 to be freed for storing a next picture.

Further, only a picture in the same access unit can be referred to during inter-view reference, and thus in the present embodiment, it is sufficient that the syntax information list 143 for inter-view reference and the frame memory mapping list 144 for inter-view reference can store therein information for at least one picture. However, in the present embodiment, the first decoding unit 121 and the second decoding unit 122 operate simultaneously, and thus the area for storing two pictures is secured in each of the syntax information list 143 for inter-view reference and the frame memory mapping list 144 for inter-view reference, the area for storing one picture being for writing by the first decoding unit 121 and the area for storing one picture being for reading by the second decoding unit 122.

Now, a description is given of the operation of the image decoding apparatus 100 in Embodiment 1 of the present invention which has a configuration in conformity with the H.264 standard and the H.264-MVC standard, as described above.

In the following, three pictures are necessary for reference per one stream. Further, an area for storing one picture which is being decoded is necessary, as described above.

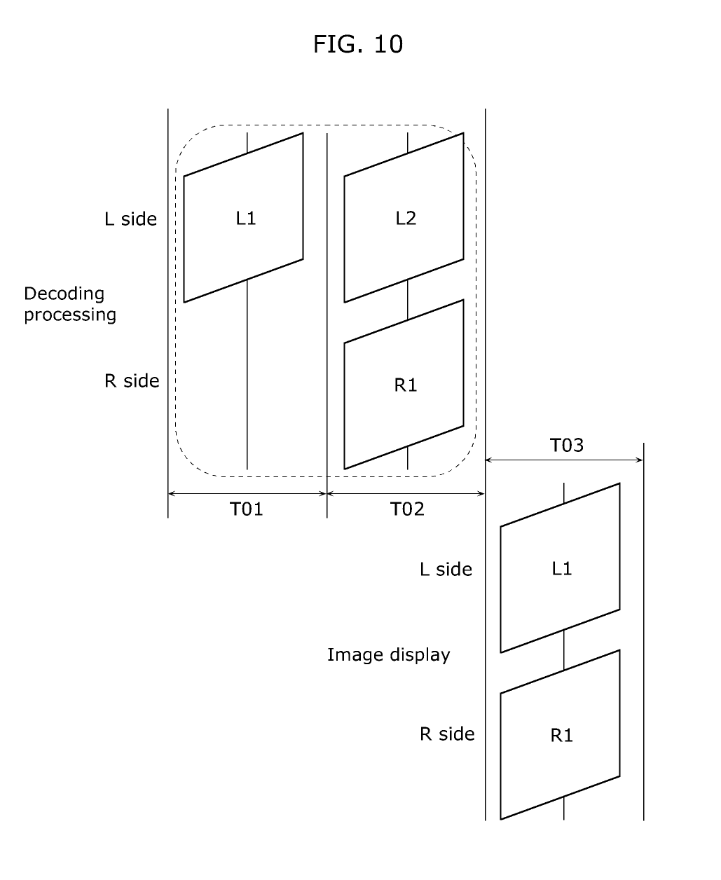

Furthermore, it is assumed that decoding an L side picture and an R side picture which belong to the same access unit is completed, and thereafter images are displayed at a timing as shown in FIG. 10. Specifically, in period T01, decoding processing is performed on an L side picture L1. Next, in period T02, decoding processing is performed on an L side picture L2 and an R side picture R1. Next, in period T03, the picture L1 and the picture R1 are displayed. It should be noted that the pictures L1 and R1 are included in the same access unit.

In this manner, decoding processing on a next picture is started before current pictures are displayed, and thus a storage area for one picture is provided for display.

Therefore, the frame memory 170 is assumed to have an area in which ten pictures in total (five L side pictures and five R side pictures) can be stored.

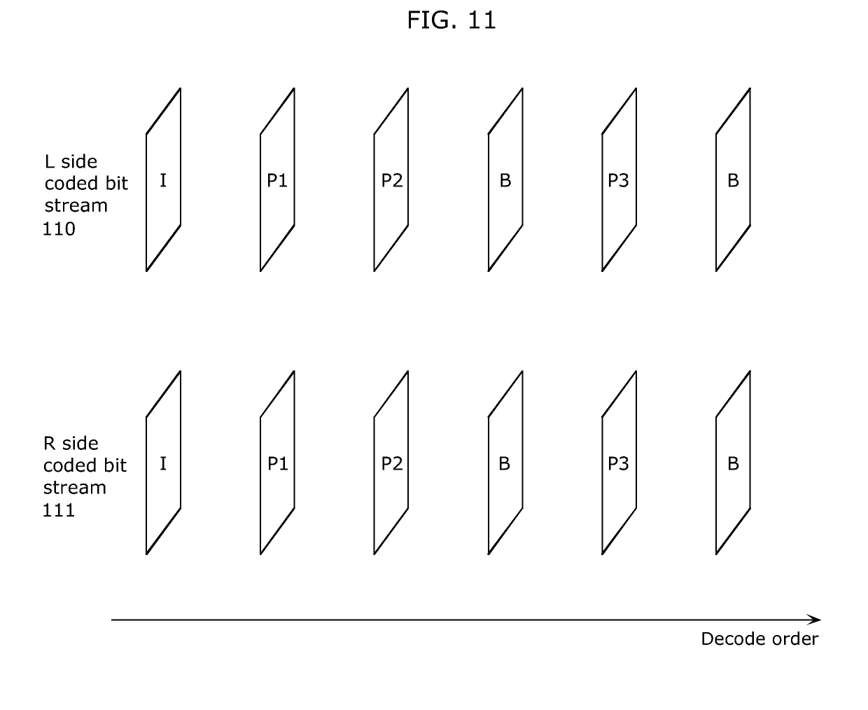

Further, multi-view coding according to H.264-MVC has been performed on the coded bit streams 110 and 111 which are input, as described above. Further, as shown in FIG. 11, pictures in the L side coded bit stream 110 are coded in the order of I, P1, P2, B1, P3, and B2. Similarly, pictures in the R side coded bit stream 111 are coded in the order of I, P1, P2, B1, P3, and B2. It should be noted that “I” shown in FIG. 11 denotes that a corresponding picture is an I-picture. Further, “P1”, “P2”, and “P3” denote that corresponding pictures are P-pictures. Also, “B” denotes that a corresponding picture is a B-picture. I-pictures are pictures on which intra-frame coding has been performed where intra-view reference is not performed. P-pictures and B-pictures are pictures coded by performing intra-view reference. In contrast, I-pictures and P-pictures are pictures used as intra-view references for other pictures, and in the present embodiment, B-pictures are pictures that are not used as intra-view references for other pictures (nal_ref_idc=0).

The L side coded bit stream 110 corresponds to a base view, and the R side coded bit stream 111 corresponds to a non base view.

First, the image decoding apparatus 100 starts decoding processing on the L side coded bit stream 110. For each picture, the first control unit 131 and the second control unit 132 are started simultaneously, and wait for the completion of processing, thereby achieving synchronization between decoding processing on the coded bit streams 110 and 111, as follows.

First is a description of decoding processing on an L side picture.

The first control unit 131 performs picture decoding processing on the L side coded bit stream 110 by controlling the first decoding unit 121 in the processing steps below.

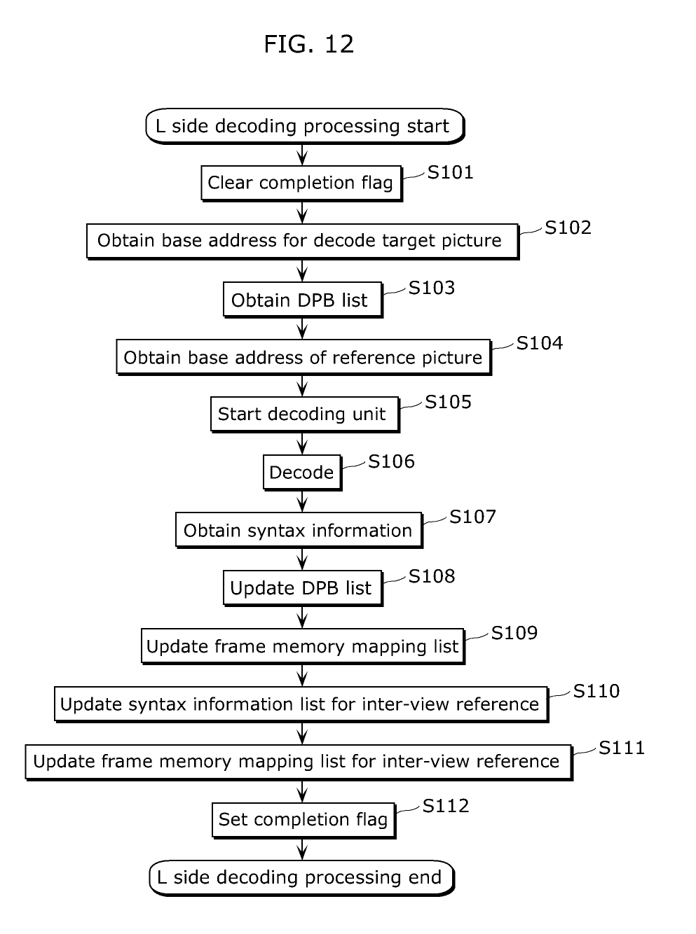

FIG. 12 is a flowchart of L side decoding processing performed by the image decoding apparatus 100.

First, the first control unit 131 clears the first completion flag stored in the flag storage unit 180 (S101).

Next, the first control unit 131 obtains, from the frame memory management unit 150, a base address in the frame memory 170 at which the result of decoding a decode target picture is to be stored (S102).

Next, the first control unit 131 obtains the L side DPB list 141a from the management information storage unit 140 (S103).

Next, the first control unit 131 obtains the frame memory mapping list 142a. Further, the first control unit 131 obtains the base address of a reference picture for intra-view reference, by referring to the obtained DPB list 141a and the obtained frame memory mapping list 142a (S104).

Next, the first control unit 131 sets the base address for the decode target picture, the base address of the reference picture, and the DPB list 141a obtained in steps S102 to S104 described above in the first decoding unit 121, and starts the first decoding unit 121 (S105).

Next, the first decoding unit 121 obtains a reference picture based on the base address of the reference picture set in step S105, and generates a decoded picture by decoding the coded bit stream 110 using the obtained reference picture. Further, the first decoding unit 121 stores the generated decoded picture at the base address for the decode target picture set in step S105. Also, the first decoding unit 121 notifies the first control unit 131 that decoding processing on the decode target picture is completed (S106).

Next, the first control unit 131 obtains, from the first decoding unit 121, the syntax information 113 of the picture for which decoding processing is completed in step S106 (S107).

Next, if the picture for which decoding processing is completed in step S106 is to be used as a reference picture when a succeeding picture is decoded, the first control unit 131 updates the DPB list 141a in the management information storage unit 140, using the syntax information 113 obtained in step S107 (S108). Specifically, the first control unit 131 adds the syntax information 113 obtained in step S107 to the DPB list 141a.

Next, if there is a picture that is excluded from the DPB list 141a due to the update of the DPB list 141a in step S108, the first control unit 131 notifies the frame memory management unit 150 of the index 201 of that picture in the DPB list 141a. If the index 201 is notified from the first control unit 131, the frame memory management unit 150 updates the frame memory mapping list 142a (S109). Specifically, the frame memory management unit 150 changes the DPB list index 204 corresponding to the notified index 201 to “not set”. Further, the frame memory management unit 150 adds information on the picture for which decoding processing is completed to the frame memory mapping list 142a.

Next, the first control unit 131 stores, into the syntax information list 143 for inter-view reference, the syntax information 113 obtained in step S107 as syntax information for inter-view reference (S110).

Next, the first control unit 131 stores information on the picture for which decoding processing is completed, into the frame memory mapping list 144 for inter-view reference (S111).

Next, the first control unit 131 once stops the L side decoding processing, and sets the first completion flag in the flag storage unit 180 (S112).

Next is a description of decoding processing on an R side picture.

The second control unit 132 performs decoding processing on the R side coded bit stream 111 by controlling the second decoding unit 122 in the processing steps below.

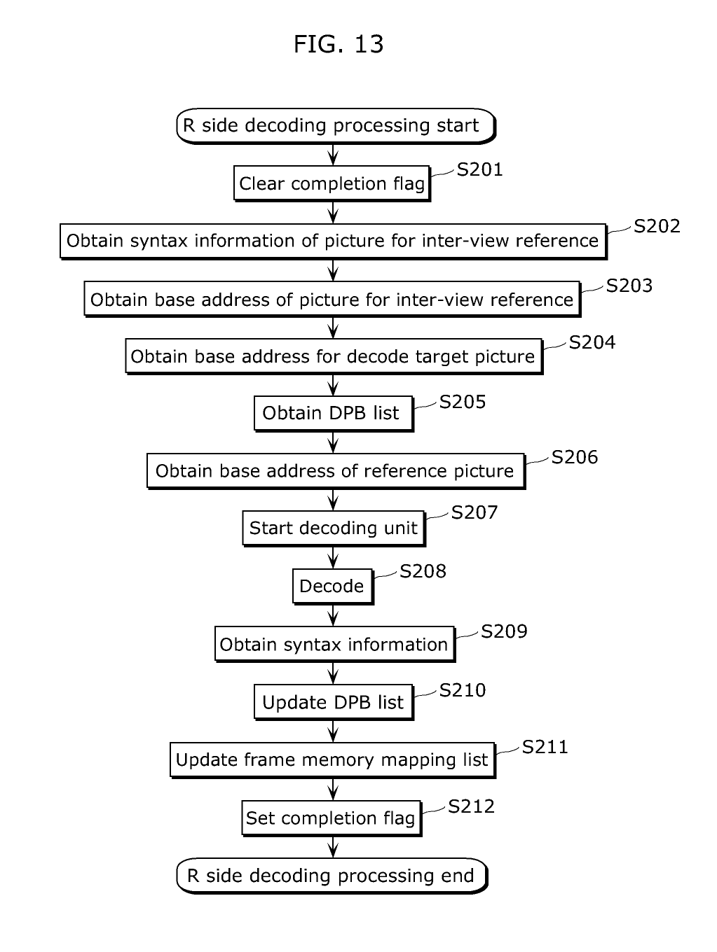

FIG. 13 is a flowchart of R side decoding processing performed by the image decoding apparatus 100.

First, the second control unit 132 clears the second completion flag stored in the flag storage unit 180 (S201).

Next, the second control unit 132 obtains, from the syntax information list 143 for inter-view reference, syntax information of an L side decoded picture which can be referred to in the decoding processing on the R side coded bit stream 111, to identify a reference picture for inter-view reference (S202).

Next, the second control unit 132 obtains a base address corresponding to the syntax information obtained in step S202, by referring to the frame memory mapping list 144 for inter-view reference. Specifically, the second control unit 132 obtains the base address of the L side decoded picture which can be referred to in the decoding processing on the R side coded bit stream 111 (S203).

Next, the second control unit 132 obtains a base address in the frame memory 170 at which the result of decoding a decode target picture (R side picture) is to be stored, from the frame memory management unit 150 (S204).

Next, the second control unit 132 obtains the R side DPB list 141b from the management information storage unit 140 (S205).

Next, the second control unit 132 obtains the frame memory mapping list 142b. Further, the second control unit 132 obtains the base address of a reference picture for intra-view reference, by referring to the obtained DPB list 141b and the obtained frame memory mapping list 142b (S206).

Next, the second control unit 132 sets, in the second decoding unit 122, the base address for the decode target picture, the base addresses of the reference picture for intra-view reference and the reference picture for inter-view reference, and the DPB list 141b for the decode target picture which are obtained in steps S203, S204, S205, and S206, and starts the second decoding unit 122 (S207).

The second decoding unit 122 obtains a reference picture based on the base address of the reference picture for intra-view reference or for inter-view reference set in step S207, and generates a decoded picture by decoding the coded bit stream 111 using the obtained reference picture. Further, the second decoding unit 122 stores the generated decoded picture at the base address for the decode target picture set in step S207. Also, the second decoding unit 122 notifies the second control unit 132 that decoding processing on the picture is completed (S208).

Next, the second control unit 132 obtains the syntax information 113 of the picture for which decoding is completed in step S208, from the second decoding unit 122 (S209).

Next, the second control unit 132 updates the DPB list 141b if the picture for which decoding is completed in step S208 is to be used as a reference picture when a succeeding picture is decoded (S210). Specifically, the second control unit 132 adds the syntax information 113 obtained in step S209 to the DPB list 141b.

Next, when there is a picture excluded from the DPB list 141b due to the update of the DPB list 141b in step S210, the second control unit 132 notifies the frame memory management unit 150 of the index 201 of that picture in the DPB list 141b. The frame memory management unit 150 updates the frame memory mapping list 142b, if the index 201 is notified from the second control unit 132 (S211). Specifically, the frame memory management unit 150 changes the DPB list index 204 corresponding to the notified index 201 to “not set”. Further, the frame memory management unit 150 adds information on the picture for which decoding processing is completed to the frame memory mapping list 142b.

Next, the second control unit 132 once stops the R side decoding processing, and sets the second completion flag in the flag storage unit 180 (S212).

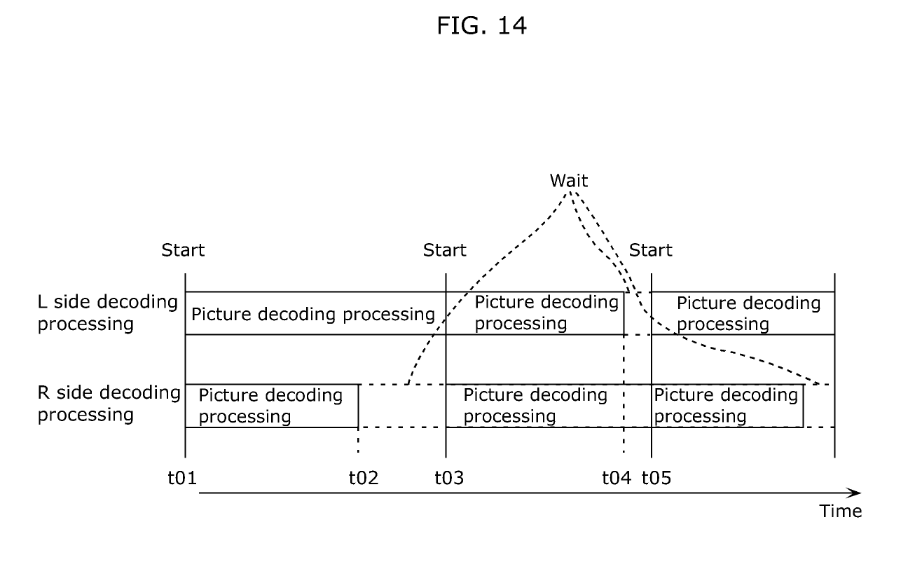

As described above, the first control unit 131 and the second control unit 132 are simultaneously started and caused to wait for the completion of processing for each picture, thereby achieving synchronization between decoding processing on the coded bit streams 110 and 111, as shown in FIG. 14.

For example, L side decoding processing and R side decoding processing are simultaneously started at time tO1 shown in FIG. 14. Specifically, processing shown in FIGS. 12 and 13 described above is performed. R side decoding processing is completed at time t02. Since L side decoding processing is not completed at time t02, the first completion flag is not set. Therefore, the second control unit 132 does not start decoding processing on the next picture until L side decoding processing is completed.

L side decoding processing is completed at time t03. Therefore, at time t03, decoding processing for both L and R sides is completed, and thus the image decoding unit 120 simultaneously starts decoding processing on the next pictures.

Further, although L side decoding processing is completed at time t04, R side decoding processing is not completed, and thus the first control unit 131 does not start decoding processing on the next picture until R side decoding processing is completed.

R side decoding processing is completed at time t05. Therefore, decoding processing for both L and R sides is completed at time t05, and thus the image decoding unit 120 simultaneously starts decoding processing on the next pictures.

In this manner, decoding processing on both the coded bit streams 110 and 111 for a unit of decoding processing previously determined (picture unit) by the first decoding unit 121 and the second decoding unit 122 is completed, and thereafter the control unit 130 causes the first decoding unit 121 and the second decoding unit 122 to start decoding processing for the next unit of decoding processing.

Specifically, when decoding processing on the coded bit stream 110 for the unit of decoding processing by the first decoding unit 121 is completed, and furthermore the second completion flag is stored in the flag storage unit 180, the first control unit 131 causes the first decoding unit 121 to start decoding processing on the coded bit stream 110 for the next unit of decoding processing.

Further, when decoding processing on the coded bit stream 111 for the unit of decoding processing by the second decoding unit 122 is completed, and furthermore the first completion flag is stored in the flag storage unit 180, the second control unit 132 causes the second decoding unit 122 to start decoding processing on the coded bit stream 111 for the next unit of decoding processing.

It should be noted that although here, decoding processing on the next L side picture is not started until R side decoding processing is completed, and decoding processing on the next R side picture is not started until L side decoding processing is completed, decoding processing on the next L side picture may be performed without waiting for the completion of R side decoding processing when L side decoding processing is completed before the completion of R side decoding processing. This is because an L side decoded picture is used as a reference picture for the R side, whereas an R side decoded picture is not used as a reference picture for the L side, and thus even if decoding processing for the L side starts prior to that for the R side, a problem does not arise that a reference picture is not yet decoded.

However, if L side decoding processing greatly precedes, a large storage area for storing L side decoded pictures is necessary for display. Alternatively, it is also possible to manage free space of the frame memory in consideration of the end of use for the R side as well, and perform control such that L side decoding processing is caused to precede as much as possible. However, such control will be complicated. Therefore, it is preferable that decoding processing on the next L side picture is not started until R side decoding processing is completed, and decoding processing on the next R side picture is not started until L side decoding processing is completed, as shown in FIG. 14.

Here, a conventional image decoding apparatus has a problem of synchronization regarding decoding processing on a plurality of bit streams.

Specifically, there are cases in which in a process of decoding image data compressed using a coding method using inter-view prediction such as H.264-MVC, in order to decode an image in a non base view, a resultant image after decoding in a base view displayed at the same time is used as a reference image during motion compensation. Therefore, there is dependency between a timing at which decoding processing is performed for a base view and a timing at which decoding processing is performed for a non base view. It should be noted that in the case of three or more viewpoints, in order to decode an image in a non base view, a decoded image in a different non base view or a base view displayed at the same time may be used as a reference image during motion compensation.

Thus, it is necessary to decode a plurality of bit streams while achieving synchronization between decoding processing for channels for each predetermined unit, and thus a problem arises that reference among channels during decoding is not properly performed, and consequently decoding processing cannot be properly performed, if a configuration is adopted in which timings at which images for channels are decoded are all arbitrarily set without taking into consideration the decoding states in other channels, and reproduction is performed during display with synchronization being achieved among channels, as with the conventional image decoding apparatus.

In contrast, the image decoding apparatus 100 according to Embodiment 1 of the present invention simultaneously starts the first control unit 131 and the second control unit 132, and also waits for completion of processing, thereby achieving synchronization between decoding processing on the coded bit streams 110 and 111.

Further, the image decoding apparatus 100 according to Embodiment 1 of the present invention can be informed of syntax management information of a reference picture obtained from the L side coded bit stream, via the common syntax information list 143 for inter-view reference which can be accessed during decoding processing on the R side coded bit stream 111. Accordingly, the image decoding apparatus 100 can decode a bit stream coded using inter-view prediction.

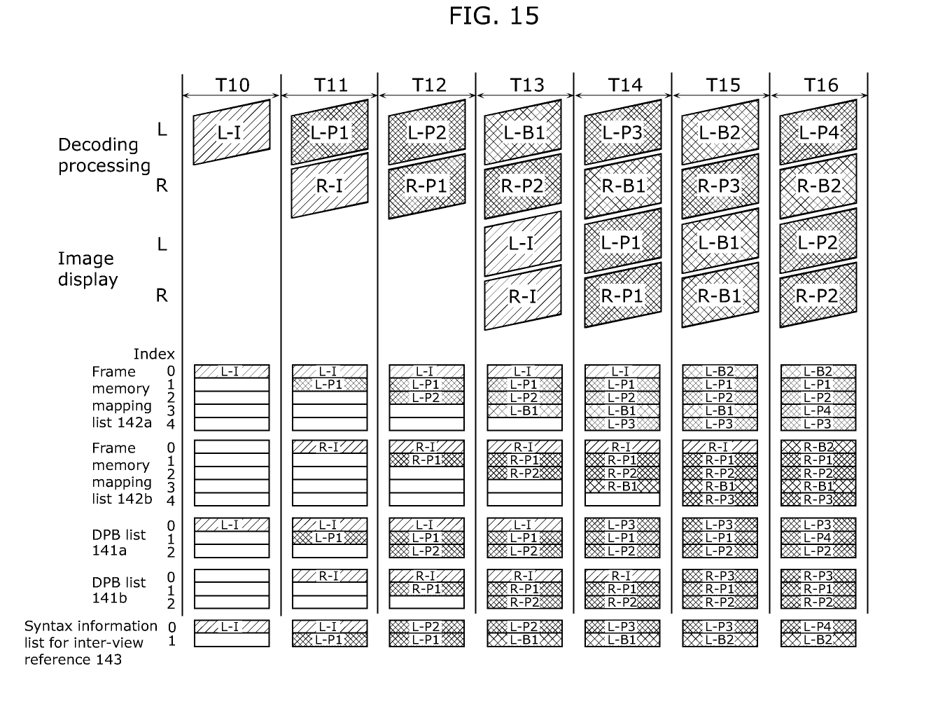

Next is a description of a relationship for one picture time among the DPB lists 141a and 141b, the frame memory mapping lists 142a and 142b, the syntax information list 143 for inter-view reference, and the frame memory mapping list 144 for inter-view reference, using FIG. 15.

### (Period T10)

### (Decoding Processing on L Side Coded Bit Stream 110)

A decoded I-picture (L-I) is stored into the frame memory 170, and the syntax information 113 thereof is registered in a portion having the index number “0” in the DPB list 141a. Also, the base address thereof is registered in a portion having the index number “0” in the frame memory mapping list 142a.

Further, the syntax information 113 of the I-picture (L-I) is registered in the syntax information list 143 for inter-view reference. Further, the base address of the I-picture (L-I) is registered in a portion having the index number “0” in the frame memory mapping list 144 for inter-view reference.

### (Decoding Processing on R Side Coded Bit Stream 111)

Since there is a possibility that inter-view reference is performed, processing on the R side coded bit stream is not performed during period T10, and starts in period T11.

### (Period T11)

### (Decoding Processing on L Side Coded Bit Stream 110)

A decoded P-picture (L-P1) is stored into the frame memory 170, and the syntax information 113 thereof is registered in a portion having the index number “1” in the DPB list 141a. Further, the base address thereof is registered in a portion having the index number “1” in the frame memory mapping list 142a. Also, the syntax information 113 of the P-picture (L-P1) is registered in a portion having the index number “1” in the syntax information list 143 for inter-view reference. Further, the base address of the P-picture (L-P1) is registered in a portion having the index number “1” in the frame memory mapping list 144 for inter-view reference.

### (Decoding Processing on R Side Coded Bit Stream 111)

A decoded I-picture (R-I) is stored into the frame memory 170, and the syntax information 113 thereof is registered in a portion having the index number “0” in the DPB list 141b. The base address thereof is registered in a portion having the index number “0” in the frame memory mapping list 142b.

### (Period T12)

### (Decoding Processing on L Side Coded Bit Stream 110)

A decoded P-picture (L-P2) is stored into the frame memory 170, and the syntax information 113 thereof is registered in a portion having the index number “2” in the DPB list 141a. The base address thereof is registered in a portion having the index number “2” in the frame memory mapping list 142a. The syntax information 113 of the P-picture (L-P2) is registered in a portion having the index number “0” in the syntax information list 143 for inter-view reference. The base address of the P-picture (L-P2) is registered in the portion having the index number “0” in the frame memory mapping list 144 for inter-view reference.

### (Decoding Processing on R Side Coded Bit Stream 111)

A decoded P-picture (R-P1) is stored into the frame memory 170, and the syntax information 113 thereof is registered in a portion having the index number “1” in the DPB list 141b. The base address thereof is registered in a portion having the index number “1” in the frame memory mapping list 142b.

### (Period T13)

### (Decoding Processing on L Side Coded Bit Stream 110)

A decoded B-picture (L-B1) is stored into the frame memory 170, and the base address thereof is registered in a portion having the index number “3” in the frame memory mapping list 142a. However, the B-picture (L-B1) is not to be referred to when a succeeding picture is decoded, and thus the syntax information 113 thereof is not registered in the DPB list 141a.

The B-picture (L-B1) is registered in the portion having the index number “1” in the syntax information list 143 for inter-view reference. The base address of the B-picture (L-B1) is registered in the portion having the index number “1” in the frame memory mapping list 144 for inter-view reference.

### (Decoding Processing on R Side Coded Bit Stream 111)

A decoded P-picture (R-P2) is stored into the frame memory 170, and the syntax information 113 thereof is registered in a portion having the index number “2” in the DPB list 141b. The base address thereof is registered in a portion having the index number “2” in the frame memory mapping list 142b.

### (Image Display of L Side Coded Bit Stream 110)

Although the I-picture (L-I) is displayed, the I-picture (L-I) can be used as a reference picture when a succeeding picture is decoded, and thus the syntax information 113 thereof registered in the portion having the index number “0” in the DPB list 141a is not erased. Similarly, the base address thereof registered in the portion having the index number “0” in the frame memory mapping list 142a is not erased.

### (Image Display of R Side Coded Bit Stream 111)

Although the I-picture (R-I) is displayed, the I-picture (R-I) can be used as a reference picture when a succeeding picture is decoded, and thus the syntax information 113 thereof registered in the portion having the index number “0” in the DPB list 141b is not erased. Similarly, the base address thereof registered in the portion having the index number “0” in the frame memory mapping list 142b is not erased.

### (Period T14)

### (Decoding Processing on L Side Coded Bit Stream 110)

A decoded P-picture (L-P3) is stored into the frame memory 170, and the syntax information 113 thereof is registered in the portion having the index number “0” in the DPB list 141a. The base address thereof is registered in a portion having the index number “4” in the frame memory mapping list 142a. At that time, the syntax information 113 of the I-picture (L-I) which has been registered in the portion having the index number “0” in the DPB list 141a and the base address of the I-picture (L-I) which has been registered in the portion having the index number “0” in the frame memory mapping list 142a are erased. Further, the P-picture (L-P3) is registered in the portion having the index number “0” in the syntax information list 143 for inter-view reference. The base address of the P-picture (L-P3) is registered in the portion having the index number “0” in the frame memory mapping list 144 for inter-view reference.

### (Decoding Processing on R Side Coded Bit Stream 111)

A decoded B-picture (R-B1) is stored into the frame memory 170, and the base address thereof is registered in a portion having the index number “3” in the frame memory mapping list 142b. The B-picture (R-B1) is not to be referred to when a succeeding picture is decoded, and thus the syntax information 113 thereof is not registered in the DPB list 141b.

### (Image Display of L Side Coded Bit Stream 110)

Although the P-picture (L-P1) is displayed, that picture can be used as a reference picture when a succeeding picture is decoded, and thus the syntax information thereof registered in the portion having the index number “1” in the DPB list 141a is not erased. Similarly, the base address thereof registered in the portion having the index number “1” in the frame memory mapping list 142a is not erased.

### (Image Display of R Side Coded Bit Stream 111)

Although the P-picture (R-P1) is displayed, that picture can be used as a reference picture when a succeeding picture is decoded, and thus the syntax information thereof registered in the portion having the index number “1” in the DPB list 141b is not erased. Similarly, the base address thereof registered in the portion having the index number “1” in the frame memory mapping list 142b is not erased.

### (Period T15)

### (Decoding Processing on L Side Coded Bit Stream 110)

A decoded B-picture (L-B2) is stored into the frame memory 170, and the base address thereof is registered in the portion having the index number “0” in the frame memory mapping list 142a. The B-picture (L-B2) is not to be referred to when a succeeding picture is decoded, and thus the syntax information 113 thereof is not registered in the DPB list 141a.

The B-picture (L-B2) is registered in the portion having the index number “1” in the syntax information list 143 for inter-view reference. Further, the base address of the B-picture (L-B2) is registered in the portion having the index number “1” in the frame memory mapping list 144 for inter-view reference.

### (Decoding Processing on R Side Coded Bit Stream 111)

A decoded P-picture (R-P3) is stored into the frame memory 170, and the syntax information 113 thereof is registered in the portion having the index number “0” in the DPB list 141b. The base address thereof is registered in a portion having the index number “4” in the frame memory mapping list 142b. At that time, the syntax information 113 of the I-picture (R-I) which has been registered in the portion having the index number “0” in the DPB list 141b, and the base address of the I-picture (R-I) which has been registered in the portion having the index number “0” in the frame memory mapping list 142b are erased.

### (Image Display of L Side Coded Bit Stream 110)

The B-picture (L-B1) is displayed, and is not used as a picture for inter-view reference, and thus the base address thereof which has been registered is erased from the portion having the index number “3” in the frame memory mapping list 142a.

### (Image Display of R Side Coded Bit Stream 111)

The B-picture (R-B1) is displayed, and is not used as a picture for inter-view reference, and thus the base address thereof which has been registered is erased from the portion having the index number “3” in the frame memory mapping list 142b.

### (Period T16)

### (Decoding Processing on L Side Coded Bit Stream 110)

A decoded P-picture (L-P4) is stored into the frame memory 170, and the syntax information 113 thereof is registered in the portion having the index number “1” in the DPB list 141b. The base address thereof is registered in the portion having the index number “3” in the frame memory mapping list 142b. At that time, the syntax information 113 of the P-picture (L-P1) which has been registered in the portion having the index number “1” in the DPB list 141a and the base address of the P-picture (L-P1) which has been registered in the portion having the index number “1” in the frame memory mapping list 142a are erased. The P-picture (L-P4) is registered in the portion having the index number “0” in the syntax information list 143 for inter-view reference. The base address of the P-picture (L-P4) is registered in the portion having the index number “0” in the frame memory mapping list 144 for inter-view reference.

### (Decoding Processing on R Side Coded Bit Stream 111)

A decoded B-picture (R-B2) is stored into the frame memory 170, and the base address thereof is registered in the portion having the index number “3” in the frame memory mapping list 142b. The B-picture (R-B2) is not to be referred to when a succeeding picture is decoded, and thus the syntax information 113 thereof is not registered in the DPB list 141b.

### (Image Display of L Side Coded Bit Stream 110)

Although the P-picture (L-P2) is displayed, that picture can be used as a reference picture when a succeeding picture is decoded, and thus the syntax information 113 thereof registered in the portion having the index number “2” in the DPB list 141a is not erased.

Similarly, the base address thereof registered in the portion having the index number “2” in the frame memory mapping list 142a is not erased.

### (Image Display of R Side Coded Bit Stream 111)

Although the P-picture (R-P2) is displayed, that picture can be used as a reference picture when a succeeding picture is decoded, and thus the syntax information thereof registered in the portion having the index number “2” in the DPB list 141b is not erased. Similarly, the base address thereof registered in the portion having the index number “2” in the frame memory mapping list 142b is not erased.

As described above, the image decoding apparatus 100 according to Embodiment 1 of the present invention simultaneously starts the first control unit 131 and the second control unit 132, and also waits for completion of processing, thereby achieving synchronization between decoding processing on the coded bit streams 110 and 111.

It should be noted that the image decoding apparatus 100 according to Embodiment 1 of the present invention is also applicable to decoding a coded bit stream based not only on the H.264 standard, but also on other standards.

Further, although the first control unit 131 and the second control unit 132 perform waiting for picture units (frame units) to achieve synchronization in the present embodiment, synchronization may be achieved for two-field picture units in the case of a field structure, for instance. Further, the first control unit 131 and the second control unit 132 may achieve synchronization for NAL units defined by the H.264 standard, such as parameter set units (units of header decoding processing) or slice units.

In fact, the first control unit 131 and the second control unit 132 described in the present embodiment may include two processors or may be two logical threads.

Although the L side coded bit stream 110 corresponds to a base view, and the R side coded bit stream 111 corresponds to a non base view in the present embodiment, the R side coded bit stream 111 may correspond to a base view, and the L side coded bit stream 110 may correspond to a non base view.

Although the present embodiment describes coded bit streams for two viewpoints, it is needless to say that effects of the present invention can be achieved even with coded bit streams for three or more viewpoints.

Further, although the DPB lists 141a and 141b, and the frame memory mapping lists 142a and 142b are individually managed for the R side coded bit stream 111 and the L side coded bit stream 110 in the present embodiment, at least either the DPB lists 141a and 141b or the frame memory mapping lists 142a and 142b may be managed based on a single list, and common indexes may be assigned thereto.

Further, the syntax information stored in the DPB lists 141a and 141b in the present embodiment is an example, and is not limited by the present embodiment.

### Embodiment 2

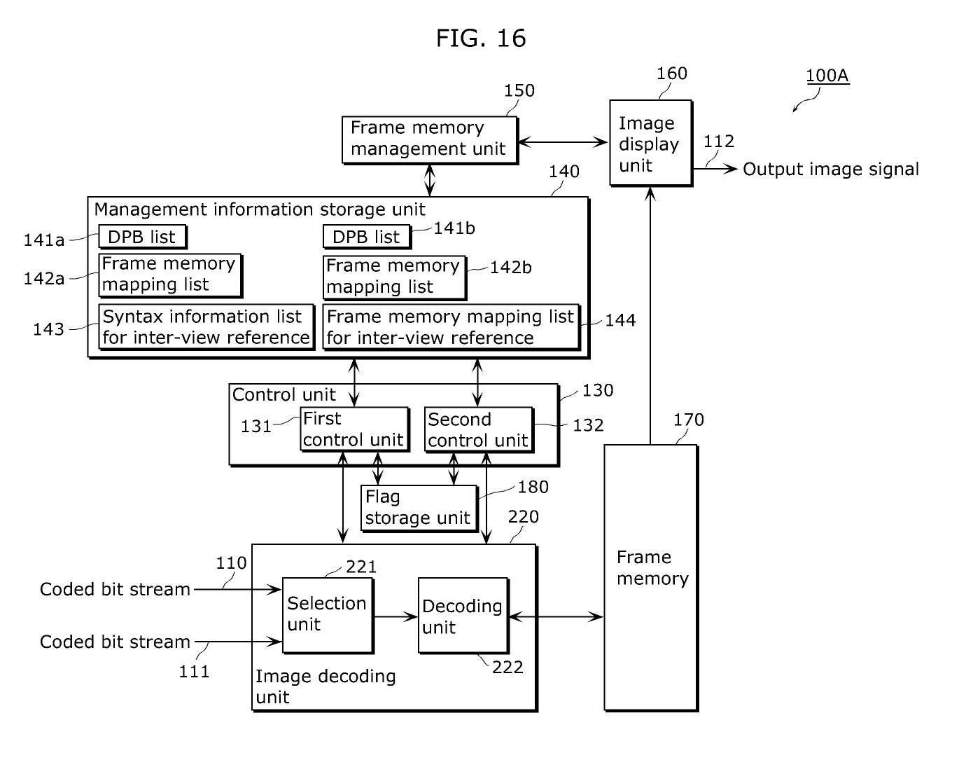

FIG. 16 shows a configuration of an image decoding apparatus 100A according to Embodiment 2 of the present invention.

The following is a description of a configuration of the image decoding apparatus 100A according to Embodiment 2 of the present invention. It should be noted that the same numerals are given to the same elements as those in FIG. 2, and the same description is omitted.

Specifically, in the image decoding apparatus 100A shown in FIG. 16, the configuration of an image decoding unit 220 is different from the configuration of the image decoding unit 120 shown in FIG. 2.

The image decoding unit 220 includes a selection unit 221 and a decoding unit 222.

The selection unit 221 selects one of coded bit streams 110 and 111, and outputs the selected coded bit stream to the decoding unit 222.

The decoding unit 222 decodes the coded bit stream output by the selection unit 221. It should be noted that the internal configuration of the decoding unit 222 is the same as that of the first decoding unit 121 and the second decoding unit 122 described in Embodiment 1.

The coded bit streams 110 and 111 input to the image decoding apparatus in the present embodiment are coded using H.264-MVC. The description of a relationship between a feature of the H.264-MVC coding and the configuration of the image decoding apparatus in the present embodiment is as given in Embodiment 1.

Now, a description is given of the operation of the image decoding apparatus 100A in Embodiment 2 of the present invention which has a configuration in conformity with the H.264 standard and the H.264-MVC standard as described above.

In the present embodiment, three pictures are necessary for reference per one stream. Further, an area for storing one picture which is being decoded is necessary, as described above.

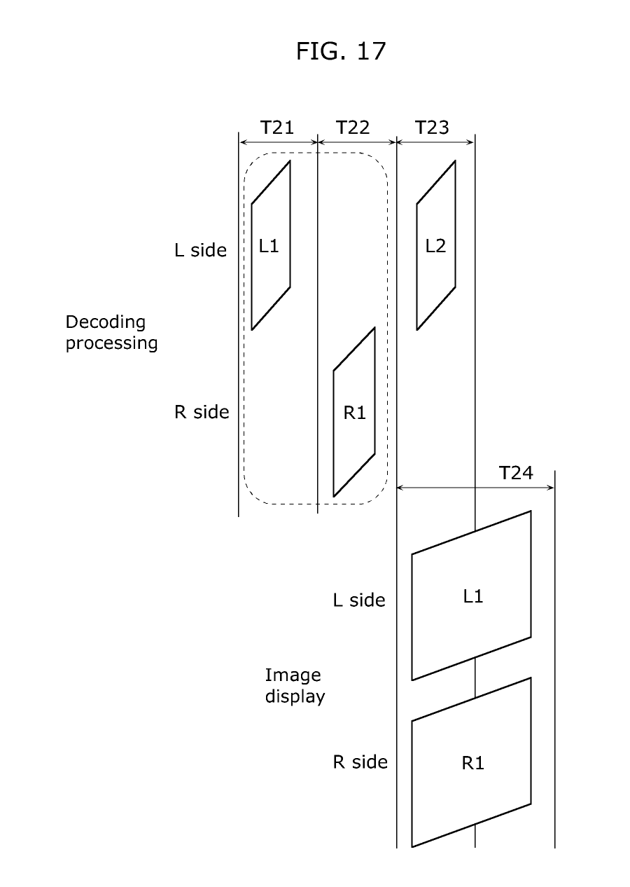

Furthermore, images are assumed to be displayed at a timing as shown in FIG. 17, after the completion of decoding an L side picture and an R side picture which belong to the same access unit. Specifically, in period T21, decoding processing is performed on an L side picture L1. Next, in period T22, decoding processing is performed on an R side picture R1. Next, in period T23, decoding processing is performed on an L side picture L2. In period T24, the pictures L1 and R1 are displayed. It should be noted that the pictures L1 and R1 are pictures included in the same access unit.

In this manner, decoding processing on the next picture is started during display, and thus a storage area for one picture is provided for display.

Therefore, the frame memory 170 is assumed to have an area in which ten pictures in total (five L side pictures and five R side pictures) can be stored.

In the present embodiment, the decoding unit 222 performs decoding processing on the coded bit stream 110 and on the coded bit stream 111 alternately, and thus an area for storing one picture is secured in the syntax information list 143 for inter-view reference and the frame memory mapping list 144 for inter-view reference.

The configuration of the coded bit streams 110 and 111 to be input is the same as that in Embodiment 1.

First, the image decoding apparatus 100A in the present embodiment starts decoding processing on the L side coded bit stream 110. The first control unit 131 and the second control unit 132 achieve synchronization between decoding processing on the coded bit streams 110 and 111 by alternately operating as follows.

First is a description of decoding processing on an L side picture.

In the processing steps below, the first control unit 131 controls the decoding unit 222, and performs picture decoding processing on the L side coded bit stream 110. It should be noted that the procedure of processing performed by the first control unit 131 is the same as that of processing shown in FIG. 12, and thus a description is given using FIG. 12.

First, the first control unit 131 clears the first completion flag stored in the flag storage unit 180 (S101).

Next, the first control unit 131 obtains, from the frame memory management unit 150, the base address in the frame memory 170 at which the result of decoding a decode target picture is to be stored (S102).

Next, the first control unit 131 obtains the L side DPB list 141a from the management information storage unit 140 (S103).

Next, the first control unit 131 obtains the frame memory mapping list 142a. Further, the first control unit 131 obtains the base address of a reference picture for intra-view reference, by referring to the obtained DPB list 141a and the obtained frame memory mapping list 142a (S104).

Next, the first control unit 131 sets, in the first decoding unit 121, the base address for the decode target picture, the base address of the reference picture, and the DPB list 141a obtained in steps S102 to S104 described above. In addition, the first control unit 131 makes setting such that the selection unit 221 selects the L side coded bit stream 110. Further, the first control unit 131 starts the decoding unit 222 (S105).

Next, the decoding unit 222 obtains a reference picture based on the base address of the reference picture set in step S105, and generates a decoded picture by decoding the coded bit stream 110 using the obtained reference picture. Further, the decoding unit 222 stores the generated decoded picture at the base address for the decode target picture set in step S105. Also, the decoding unit 222 notifies the first control unit 131 that decoding processing on the decode target picture is completed (S106).

Next, the first control unit 131 obtains, from the decoding unit 222, the syntax information 113 of the picture for which decoding processing is completed in step S106 (S107).

Next, if the picture for which decoding processing is completed in step S106 is to be used as a reference picture when a succeeding picture is decoded, the first control unit 131 updates the DPB list 141a in the management information storage unit 140, using the syntax information 113 obtained in step S107 (S108).

Next, if there is a picture that is excluded from the DPB list 141a due to the update of the DPB list 141a in step S108, the first control unit 131 notifies the frame memory management unit 150 of the index 201 of that picture in the DPB list 141a. If the index 201 is notified from the first control unit 131, the frame memory management unit 150 updates the frame memory mapping list 142a (S109).

Next, the first control unit 131 stores, into the syntax information list 143 for inter-view reference, the syntax information 113 obtained in step S107 as syntax information for inter-view reference (S110).

Next, the first control unit 131 stores the base address obtained in step S102 into the frame memory mapping list 144 for inter-view reference (S111).

Next, the first control unit 131 once stops the L side decoding processing, and sets the first completion flag in the flag storage unit 180 (S112).

Next is a description of decoding processing on an R side picture.

A series of decoding processes on the L side coded bit stream 110 is completed in steps S101 to S112 described above, and thereafter, the second control unit 132 controls the decoding unit 222 and performs decoding processing on the R side coded bit stream 111 in the following processing steps.

It should be noted that the procedure of processing performed by the second control unit 132 is the same as that of processing shown in FIG. 13, and thus a description is given using FIG. 13.

First, the second control unit 132 clears the second completion flag stored in the flag storage unit 180 (S201).

Next, the second control unit 132 obtains, from the syntax information list 143 for inter-view reference in the management information storage unit 140, the syntax information 113 of an L side decoded picture which can be referred to in the decoding processing on the R side coded bit stream 111, and identifies a reference picture for inter-view reference (S202).

Next, the second control unit 132 obtains the base address of the L side decoded picture which can be referred to in the decoding processing on the R side coded bit stream 111, from the frame memory mapping list 144 for inter-view reference in the management information storage unit 140 (S203).

Next, the second control unit 132 obtains, from the frame memory management unit 150, a base address in the frame memory 170 at which the result of decoding a decode target picture (R side picture) is to be stored (S204).

Next, the second control unit 132 obtains the R side DPB list 141b from the management information storage unit 140 (S205).

Next, the second control unit 132 obtains the frame memory mapping list 142b. Further, the second control unit 132 obtains the base address of a reference picture for intra-view reference, by referring to the obtained DPB list 141b and the obtained frame memory mapping list 142b (S206).

Next, the second control unit 132 sets, in the decoding unit 222, the base address for the decode target picture, the base addresses of the reference picture for intra-view reference and the reference picture for inter-view reference, and the DPB list 141b for the decode target picture which are obtained in steps S203, S204, S205, and S206. In addition, the second control unit 132 makes settings such that the selection unit 221 selects the R side coded bit stream 111. Further, the second control unit 132 starts the decoding unit 222 (S207).

Next, the decoding unit 222 obtains a reference picture based on the base address for intra-view reference or for inter-view reference set in step S207, and generates a decoded picture by decoding the coded bit stream 111 using the obtained reference picture. Further, the decoding unit 222 stores the generated decoded picture at the base address for the decode target picture set in step S207. Also, the decoding unit 222 notifies the second control unit 132 that decoding processing on that picture is completed (S208).

Next, the second control unit 132 obtains, from the decoding unit 222, the syntax information 113 of the picture for which decoding is completed in step S208 (S209).

Next, the second control unit 132 updates the DPB list 141b if the picture for which decoding is completed in step S208 is to be used as a reference picture when a succeeding picture is decoded (S210).

Next, when there is a picture excluded from the DPB list 141b due to the update of the DPB list 141b in step S210, the second control unit 132 notifies the frame memory management unit 150 of the index 201 of that picture in the DPB list 141b. The frame memory management unit 150 updates the frame memory mapping list 142b, if the index 201 is notified from the second control unit 132 (S211).

Next, the second control unit 132 once stops the R side decoding processing, and sets the second completion flag in the flag storage unit 180 (S212).

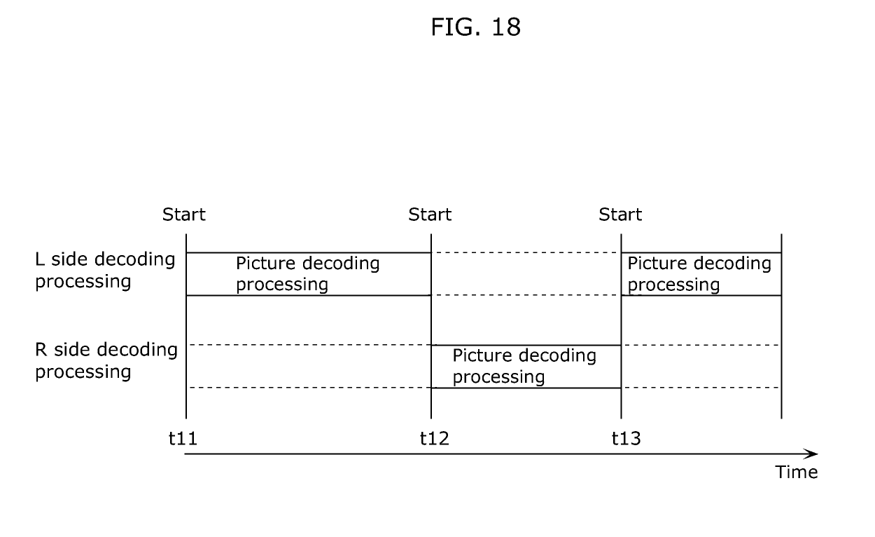

As described above, the first control unit 131 and the second control unit 132 are caused to operate alternately, thereby achieving synchronization between decoding processing on the coded bit streams 110 and 111, as shown in FIG. 18. For example, L side decoding processing is started at time t11 shown in FIG. 18. Specifically, the processing shown in FIG. 12 described above is performed. Further, L side decoding processing ends at time t12, and R side decoding processing is started next. Specifically, the processing shown in FIG. 13 described above is performed. Further, R side decoding processing ends at time t13, and L side decoding processing is started next.

In this manner, the control unit 130 causes the selection unit 221 to select one of the coded bit streams 110 and 111. Further, after the completion of decoding processing on the selected signal for a unit of decoding processing previously determined, the control unit 130 causes the selection unit 221 to select the other of the coded bit streams 110 and 111.

Specifically, the first control unit 131 causes the decoding unit 222 to start decoding processing on the coded bit stream 110 for the next unit of decoding processing, if the second completion flag is stored in the flag storage unit 180.

If the first completion flag is stored in the flag storage unit 180, the second control unit 132 causes the decoding unit 222 to start decoding processing on the coded bit stream 111 for the next unit of decoding processing.

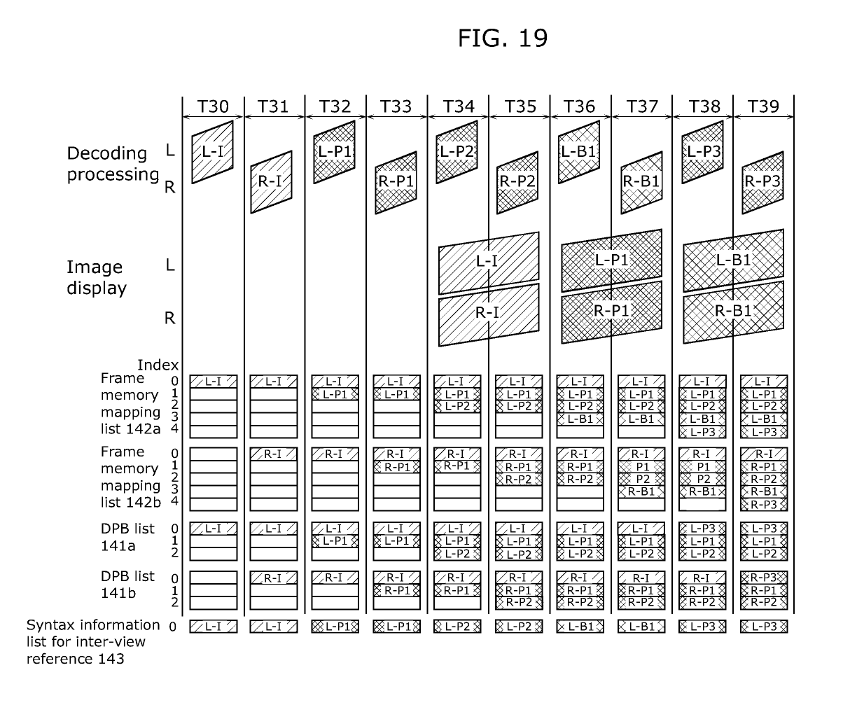

Next is a description of a relationship for one picture time among the DPB lists 141a and 141b, the frame memory mapping lists 142a and 142b, the syntax information list 143 for inter-view reference, and the frame memory mapping list 144 for inter-view reference, using FIG. 19.

### (Period T30)

### (Decoding Processing on L Side Coded Bit Stream 110)

A decoded I-picture (L-I) is stored into the frame memory 170, and the syntax information 113 thereof is registered in a portion having the index number “0” in the DPB list 141a. Also, the base address thereof is registered in a portion having the index number “0” in the frame memory mapping list 142a.

Further, the syntax information 113 of the I-picture (L-I) is registered in a portion having the index number “0” in the syntax information list 143 for inter-view reference. Further, the base address of the I-picture (L-I) is registered in a portion having the index number “0” in the frame memory mapping list 144 for inter-view reference.

### (Period T31)

### (Decoding Processing on R Side Coded Bit Stream 111)

A decoded I-picture (R-I) is stored into the frame memory, and the syntax information 113 thereof is registered in a portion having the index number “0” in the DPB list 141b. Further, the base address thereof is registered in a portion having the index number “0” in the frame memory mapping list 142b.

### (Period T32)

### (Decoding Processing on L Side Coded Bit Stream 110)

A decoded P-picture (L-P1) is stored into the frame memory, and the syntax information 113 thereof is registered in a portion having the index number “1” in the DPB list 141a. Further, the base address thereof is registered in a portion having the index number “1” in the frame memory mapping list 142a.

Also, the syntax information 113 of the P-picture (L-P1) is registered in the portion having the index number “0” in the syntax information list 143 for inter-view reference. Further, the base address of the P-picture (L-P1) is registered in the portion having the index number “0” in the frame memory mapping list 144 for inter-view reference.

### (Period T33)

### (Decoding Processing on R Side Coded Bit Stream 111)

A decoded P-picture (R-P1) is stored into the frame memory, and the syntax information 113 thereof is registered in a portion having the index number “1” in the DPB list 141b. Further, the base address thereof is registered in a portion having the index number “1” in the frame memory mapping list 142b.

### (Period T34)

### (Decoding Processing on L Side Coded Bit Stream 110)

A decoded P-picture (L-P2) is stored into the frame memory, and the syntax information 113 thereof is registered in a portion having the index number “2” in the DPB list 141a. Also, the base address thereof is registered in a portion having the index number “2” in the frame memory mapping list 142a.

In addition, the syntax information 113 of the P-picture (L-P2) is registered in the portion having the index number “0” in the syntax information list 143 for inter-view reference. Also, the base address of the P-picture (L-P2) is registered in the portion having the index number “0” in the frame memory mapping list 144 for inter-view reference.

### (Image Display of L Side Coded Bit Stream 110)

Although the I-picture (L-I) is displayed after decoding processing, the I-picture can be used as a reference picture when a succeeding picture is decoded, and thus the syntax information 113 thereof registered in the portion having the index number “0” in the DPB list 141a is not erased. Similarly, the base address thereof registered in the portion having the index number “0” in the frame memory mapping list 142a is not erased.

### (Image Display of R Side Coded Bit Stream 111)

Although the I-picture (R-I) is displayed after decoding processing, the I-picture can be used as a reference picture when a succeeding picture is decoded, and thus the syntax information 113 thereof registered in the portion having the index number “0” in the DPB list 141b is not erased. Similarly, the base address thereof registered in the portion having the index number “0” in the frame memory mapping list 142b is not erased.

### (Period T35)

### (Decoding Processing on R Side Coded Bit Stream 111)

A decoded P-picture (R-P2) is stored into the frame memory, and the syntax information 113 thereof is registered in a portion having the index number “2” in the DPB list 141b. The base address thereof is registered in a portion having the index number “2” in the frame memory mapping list 142b.

### (Period T36)

### (Decoding Processing on L Side Coded Bit Stream 110)

Although a decoded B-picture (L-B1) is stored into the frame memory, and the base address thereof is registered in a portion having the index number “3” in the frame memory mapping list 142a, the syntax information 113 thereof is not registered in the DPB list 141a, since the B-picture is not to be referred to when a succeeding picture is decoded.

### (Image Display of L Side Coded Bit Stream 110)

Although the P-picture (L-P1) is displayed after decoding processing, the P-picture can be used as a reference picture when a succeeding picture is decoded, and thus the syntax information 113 thereof registered in the portion having the index number “1” in the DPB list 141a is not erased. Similarly, the base address thereof registered in the portion having the index number “1” in the frame memory mapping list 142a is not erased.

### (Image Display of R Side Coded Bit Stream 111)

Although the P-picture (R-P1) is displayed after decoding processing, the P-picture can be used as a reference picture when a succeeding picture is decoded, and thus the syntax information 113 thereof registered in the portion having the index number “1” in the DPB list 141b is not erased. Similarly, the base address thereof registered in the portion having the index number “1” in the frame memory mapping list 142b is not erased.

### (Period T37)

### (Decoding Processing on R Side Coded Bit Stream 111)

Although a decoded B-picture (R-B1) is stored into the frame memory, and the base address thereof is registered in a portion having the index number “3” in the frame memory mapping list 142b, the syntax information 113 thereof is not registered in the DPB list 141b, since the B-picture is not to be referred to when a succeeding picture is decoded.

### (Period T38)

### (Decoding Processing on L Side Coded Bit Stream 110)

A decoded P-picture (L-P3) is stored into the frame memory, and the syntax information 113 thereof is registered in the portion having the index number “0” in the DPB list 141b. The base address thereof is registered in a portion having the index number “4” in the frame memory mapping list 142b. At that time, the syntax information 113 of the I-picture (L-I) which has been registered in the portion having the index number “0” in the DPB list 141a, and the base address of the I-picture (L-I) which has been registered in the portion having the index number “0” in the frame memory mapping list 142a are erased. The syntax information 113 of the P-picture (L-P3) is registered in the portion having the index number “0” in the syntax information list 143 for inter-view reference. Further, the base address of the P-picture (L-P3) is registered in the portion having the index number “0” in the frame memory mapping list 144 for inter-view reference.

### (Image Display of L Side Coded Bit Stream 111)

The B-picture (L-B1) is displayed, and is not used as a picture for inter-view reference, and thus the registered base address is erased from the portion having the index number “3” in the frame memory mapping list 142a.

### (Image Display of R Side Coded Bit Stream 111)

The B-picture (R-B1) is displayed, and is not used as a picture for inter-view reference, and thus the registered base address is erased from the portion having the index number “3” in the frame memory mapping list 142b.

### (Period T39)

### (Decoding Processing on R Side Coded Bit Stream 111)

A decoded P-picture (R-P3) is stored into the frame memory, and the syntax information 113 thereof is registered in the portion having the index number “0” in the DPB list 141b. Also, the base address thereof is registered in the portion having the index number “4” in the frame memory mapping list 142b. At that time, the syntax information of the I-picture (R-I) which has been registered in the portion having the index number “0” in the DPB list 141b, and the base address of the I-picture (R-I) which has been registered in the portion having the index number “0” in the frame memory mapping list 142b are erased.

In this manner, the image decoding apparatus 100A according to Embodiment 2 of the present invention causes the first control unit 131 and the second control unit 132 to operate alternately, thereby achieving synchronization between decoding processing on the coded bit streams 110 and 111.

Further, the image decoding apparatus 100A according to Embodiment 2 of the present invention can be informed of syntax management information of a reference picture obtained from the L side coded bit stream 110, via the common syntax information list 143 for inter-view reference which can be accessed during decoding processing on the R side coded bit stream 111. Accordingly, the image decoding apparatus 100A can decode a bit stream coded using inter-view prediction.

It should be noted that the image decoding apparatus 100A according to Embodiment 2 of the present invention is also applicable to decoding a coded bit stream based not only on the H.264 standard but also on other standards.

Further, although the first control unit 131 and the second control unit 132 perform waiting for picture units (frame units) to achieve synchronization in the present embodiment, synchronization may be achieved for two-field picture units in the case of a field structure, for instance. Further, the first control unit 131 and the second control unit 132 may achieve synchronization for NAL units defined by the H.264 standard, such as parameter set units (units of header decoding processing) or slice units.

In fact, the first control unit 131 and the second control unit 132 described in the present embodiment may include two processors or may be two logical threads.

Although the L side coded bit stream 110 corresponds to a base view, and the R side coded bit stream 111 corresponds to a non base view in the present embodiment, the R side coded bit stream 111 may correspond to a base view, and the L side coded bit stream 110 may correspond to a non base view.

Although the present embodiment describes coded bit streams for two viewpoints, it is needless to say that effects of the present invention can be achieved even with coded bit streams for three or more viewpoints.

Further, although the DPB lists 141a and 141b, and the frame memory mapping lists 142a and 142b are individually managed for the R side coded bit stream 111 and the L side coded bit stream 110 in the present embodiment, at least either the DPB lists 141a and 141b or the frame memory mapping lists 142a and 142b may be managed based on a single list, and common indexes may be assigned thereto.

Further, the syntax information stored in the DPB lists 141a and 141b in the present embodiment is an example, and is not limited by the present embodiment.

### Embodiment 3

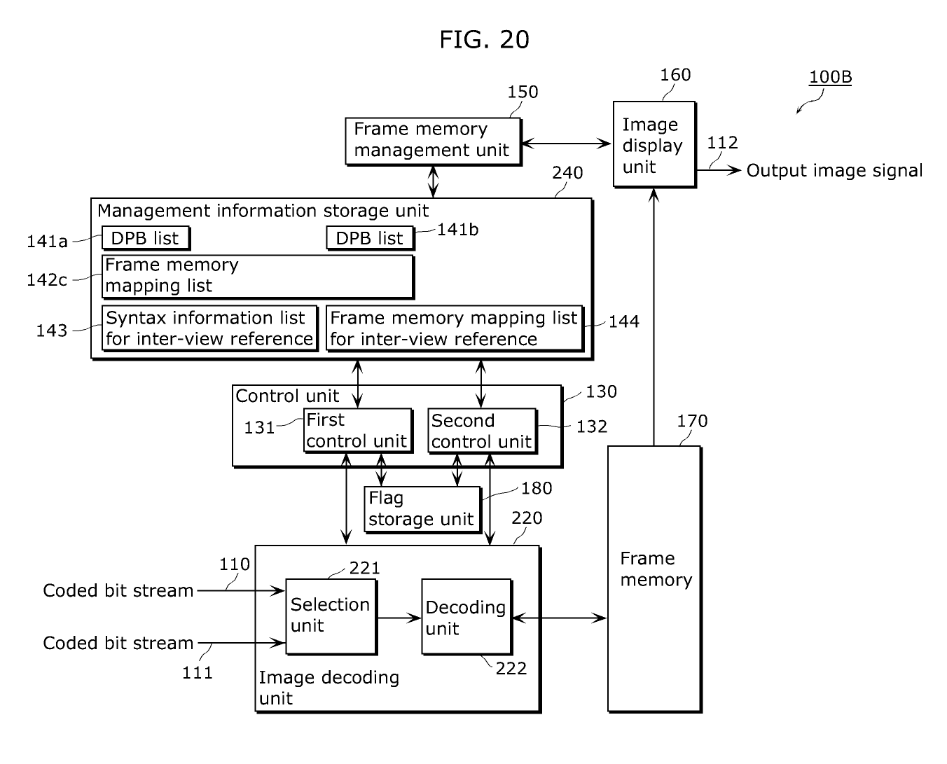

FIG. 20 shows a configuration of an image decoding apparatus 100B according to Embodiment 3 of the present invention.

The following is a description of a configuration of the image decoding apparatus 100B according to Embodiment 3 of the present invention. It should be noted that the same numerals are given to the same elements as those in FIG. 16, and the same description is omitted.

Specifically, in the image decoding apparatus 100B shown in FIG. 20, the configuration of a management information storage unit 240 is different from the configuration of the management information storage unit 140 shown in FIG. 16. More specifically, the management information storage unit 240 stores a frame memory mapping list 142c, instead of the frame memory mapping lists 142a and 142b shown in FIG. 16.

In the present embodiment, the state of the frame memory 170 is managed using the frame memory mapping list 142c.

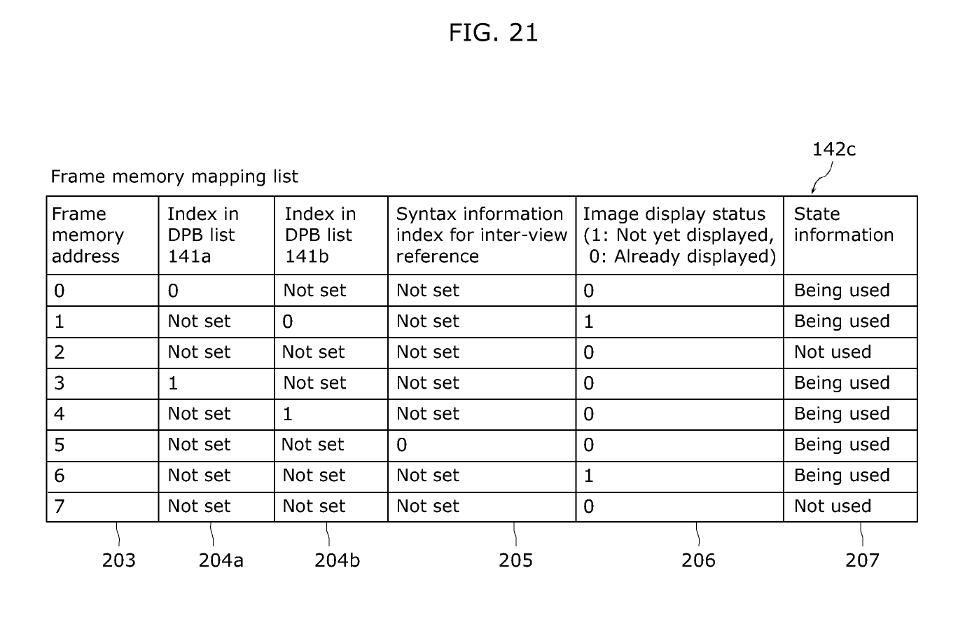

FIG. 21 shows the configuration of the frame memory mapping list 142c. For example, the frame memory mapping list 142c is in a table format as shown in FIG. 21. It should be noted that the same numerals are given to the same elements as those in FIG. 7.

As shown in FIG. 21, the frame memory mapping list 142c includes a plurality of entries each associated with a decoded picture. Each entry includes a frame memory address 203, DPB list indexes 204a and 204b, a syntax information index 205 for inter-view reference, an image display status 206, and state information 207.

The DPB list index 204a shows an index 201 in a DPB list 141a corresponding to a decoded picture.

The DPB list index 204b shows an index 201 in a DPB list 141b corresponding to the decoded picture.

In the example shown in FIG. 21, the entries for which the respective frame memory addresses 203 indicate “0” and “3” are each used as a decoded picture buffer (DPB) for L side decoding processing, and corresponding indexes 201 given in the DPB list 141a are assigned thereto. Further, the entries for which the respective frame memory addresses 203 indicate “1” and “4” are each used as a decoded picture buffer (DPB) for R side decoding processing, and corresponding indexes 201 given in the DPB list 141b are assigned thereto. Further, the entry for which the frame memory address 203 indicates “5” is used as a picture for inter-view reference, and a corresponding index 201 given in the syntax information list 143 for inter-view reference is assigned thereto. Further, the entry for which the frame memory address 203 indicates “6” is used as a temporary buffer (a picture which has not been displayed is stored), and thus cannot be used. Therefore, in this example, it can be specified that the entries for which the respective frame memory addresses 203 indicate “1” and “6” are not used, the entries not each being used as a decoded picture buffer (DPB) nor as a temporary buffer.

Coded bit streams 110 and 111 input to the image decoding apparatus 100B of the present embodiment are coded using H.264-MVC. Further, the description of a relationship between a feature of the H.264-MVC coding and the configuration of the image decoding apparatus in the present embodiment is as given in Embodiment 1.

A description is now given of the operation of the image decoding apparatus 100B in Embodiment 3 of the present invention which has a configuration in conformity with the H.264 standard and the H.264-MVC standard as described above.

In the present embodiment, three pictures are necessary for reference per one stream, as in Embodiment 2. Further, an area for storing one picture which is being decoded is necessary, as described above. Furthermore, images are assumed to be displayed at a timing as shown in FIG. 17, after the completion of decoding an L side picture and an R side picture which belong to the same access unit. In this manner, decoding processing on the next picture is started during display, and thus a storage area for one picture is provided for display. Note that this storage area is managed in common for the L side coded bit stream and the R side coded bit stream, thereby enabling reduction in the storage area for one picture, compared with Embodiment 2. Therefore, the frame memory 170 is assumed to include an area in which nine pictures in total can be stored.

First, the image decoding apparatus 100B of the present embodiment starts decoding processing on the L side coded bit stream 110. As in Embodiment 2, the first control unit 131 and the second control unit 132 operate alternately, thereby achieving synchronization between decoding processing on the coded bit streams 110 and 111.

The following is a description of a relationship for one picture time among the DPB lists 141a and 141b, the frame memory mapping list 142c, the syntax information list 143 for inter-view reference, and the frame memory mapping list 144 for inter-view reference, using FIG.

### (Period T40)

### (Decoding Processing on L Side Coded Bit Stream 110)

A decoded I-picture (L-I) is stored into the frame memory 170, and the syntax information 113 thereof is registered in a portion having the index number “0” in the DPB list 141a. The base address thereof is registered in a portion having the index number “0” in the frame memory mapping list 142c.

In addition, the syntax information 113 of the I-picture (L-I) is registered in a portion having the index number “0” in the syntax information list 143 for inter-view reference. Also, the base address of the I-picture (L-I) is registered in a portion having the index number “0” in the frame memory mapping list 144 for inter-view reference.

### (Period T41)

### (Decoding Processing on R Side Coded Bit Stream 111)

A decoded I-picture (R-I) is stored into the frame memory, and the syntax information 113 thereof is registered in a portion having the index number “0” in the DPB list 141b. The base address thereof is registered in a portion having the index number “1” in the frame memory mapping list 142c.

### (Period T42)

### (Decoding Processing on L Side Coded Bit Stream 110)

A decoded P-picture (L-P1) is stored into the frame memory, and the syntax information 113 thereof is registered in a portion having the index number “1” in the DPB list 141a. The base address thereof is registered in a portion having the index number “2” in the frame memory mapping list 142c.

The syntax information 113 of the P-picture (L-P1) is registered in the portion having the index number “0” in the syntax information list 143 for inter-view reference. The base address of the P-picture (L-P1) is registered in the portion having the index number “0” in the frame memory mapping list 144 for inter-view reference.

### (Period T43)

### (Decoding Processing on R Side Coded Bit Stream 111)

A decoded P-picture (R-P1) is stored into the frame memory, and the syntax information 113 thereof is registered in a portion having the index number “1” in the DPB list 141b. Also, the base address thereof is registered in a portion having the index number “3” in the frame memory mapping list 142c.

### (Period T44)

### (Decoding Processing on L Side Coded Bit Stream 110)

A decoded P-picture (L-P2) is stored into the frame memory, and the syntax information 113 thereof is registered in a portion having the index number “2” in the DPB list 141a. Also, the base address thereof is registered in a portion having the index number “4” in the frame memory mapping list 142c.

The syntax information 113 of the P-picture (L-P2) is registered in the portion having the index number “0” in the syntax information list 143 for inter-view reference. In addition, the base address of the P-picture (L-P2) is registered in the portion having the index number “0” in the frame memory mapping list 144 for inter-view reference.

### (Image Display of L Side Coded Bit Stream 110)

Although the I-picture (L-I) is displayed after decoding processing, the I-picture can be used as a reference picture when a succeeding picture is decoded, and thus the syntax information 113 thereof registered in the portion having the index number “0” in the DPB list 141a is not erased. Similarly, the base address thereof registered in the portion having the index number “0” in the frame memory mapping list 142c is not erased.

### (Image Display of R Side Coded Bit Stream 111)

Although the I-picture (R-I) is displayed after decoding processing, the I-picture can be used as a reference picture when a succeeding picture is decoded, and thus the syntax information 113 thereof registered in the portion having the index number “0” in the DPB list 141b is not erased. Similarly, the base address thereof registered in the portion having the index number “1” in the frame memory mapping list 142c is not erased.

### (Period T45)

### (Decoding Processing on R Side Coded Bit Stream 111)

A decoded P-picture (R-P2) is stored into the frame memory, and the syntax information 113 thereof is registered in a portion having the index number “2” in the DPB list 141b. Further, the base address thereof is registered in a portion having the index number “5” in the frame memory mapping list 142c.

### (Period T46)

### (Decoding Processing on L Side Coded Bit Stream 110)

Although a decoded B-picture (L-B1) is stored into the frame memory, and the base address thereof is registered in a portion having the index number “6” in the frame memory mapping list 142c, the syntax information 113 thereof is not registered in the DPB list 141a since the B-picture is not to be referred to when a succeeding picture is decoded.

### (Image Display of L Side Coded Bit Stream 110)

Although the P-picture (L-P1) is displayed after decoding processing, the P-picture can be used as a reference picture when a succeeding picture is decoded, and thus the syntax information 113 thereof registered in the portion having the index number “1” in the DPB list 141a is not erased. Similarly, the base address thereof registered in the portion having the index number “2” in the frame memory mapping list 142c is not erased.

### (Image Display of R Side Coded Bit Stream 111)

Although the P-picture (R-P1) is displayed after decoding processing, the P-picture can be used as a reference picture when a succeeding picture is decoded, and thus the syntax information 113 thereof registered in the portion having the index number “1” in the DPB list 141b is not erased. Similarly, the base address registered in the portion having the index number “3” in the frame memory mapping list 142c is not erased.

### (Period T47)

### (Decoding Processing on R Side Coded Bit Stream 111)

Although a decoded B-picture (R-B1) is stored into the frame memory, and the base address thereof is registered in a portion having the index number “7” in the frame memory mapping list 142c, the syntax information 113 thereof is not registered in the DPB list 141b, since the B-picture is not to be referred to when a succeeding picture is decoded.

### (Period T48)

### (Decoding Processing on L Side Coded Bit Stream 110)

A decoded P-picture (L-P3) is stored into the frame memory, and the syntax information 113 thereof is registered in the portion having the index number “0” in the DPB list 141a. Also, the base address thereof is registered in a portion having the index number “8” in the frame memory mapping list 142c. At that time, the syntax information of the I-picture (L-I) which has been registered in the portion having the index number “0” in the DPB list 141a and the base address of the I-picture (L-I) which has been registered in the portion having the index number “0” in the frame memory mapping list 142c are erased. The syntax information 113 of the P-picture (L-P3) is registered in the portion having the index number “0” in the syntax information list 143 for inter-view reference. Also, the base address of the P-picture (L-P3) is registered in the portion having the index number “0” in the frame memory mapping list 144 for inter-view reference.

### (Image Display of L Side Coded Bit Stream 111)

The B-picture (L-B1) is displayed, and is not used as a picture for inter-view reference, and thus the registered base address is erased from the portion having the index number “6” in the frame memory mapping list 142c.

### (Image Display of R Side Coded Bit Stream 111)

The B-picture (R-B1) is displayed, and is not used as a picture for inter-view reference, and thus the registered base address is erased from the portion having the index number “7” in the frame memory mapping list 142c.

### (Period T49)

### (Decoding Processing on R Side Coded Bit Stream 111)

A decoded P-picture (R-P3) is stored into the frame memory, and the syntax information 113 thereof is registered in the portion having the index number “0” in the DPB list 141b. Also, the base address thereof is registered in the portion having the index number “0” in the frame memory mapping list 142c. At that time, the syntax information of the I-picture (R-I) which has been registered in the portion having the index number “0” in the DPB list 141b, and the base address of the I-picture (R-I) which has been registered in the portion having the index number “0” in the frame memory mapping list 142c are erased.

In this manner, the image decoding apparatus 100B according to Embodiment 3 of the present invention causes the first control unit 131 and the second control unit 132 to operate alternately, thereby achieving synchronization between decoding processing on the coded bit streams 110 and 111.

Further, the image decoding apparatus 100B according to Embodiment 3 of the present invention can be informed of syntax management information of a reference picture obtained from the L side coded bit stream 110, via the common syntax information list 143 for inter-view reference which can be accessed during decoding processing on the R side coded bit stream 111. Accordingly, the image decoding apparatus 100B can decode a bit stream coded using inter-view prediction.

Furthermore, the image decoding apparatus 100B manages the frame memory mapping list 142c in common for the L side coded bit stream 110 and the R side coded bit stream 111, thereby reducing the capacity of the frame memory 170. Therefore, the cost of the image decoding apparatus 100B can be reduced.

It should be noted that the image decoding apparatus 100B according to Embodiment 3 of the present invention is also applicable to decoding a coded bit stream based not only on the H.264 standard, but also on other standards.

Further, although the first control unit 131 and the second control unit 132 perform waiting for picture units (frame units) to achieve synchronization in the present embodiment, synchronization may be achieved for two-field picture units in the case of a field structure, for instance. Further, the first control unit 131 and the second control unit 132 may achieve synchronization for NAL units defined by the H.264 standard, such as parameter set units (units of header decoding processing) or slice units.

In fact, the first control unit 131 and the second control unit 132 described in the present embodiment may include two processors or may be two logical threads.

Although the L side coded bit stream 110 corresponds to a base view, and the R side coded bit stream 111 corresponds to a non base view in the present embodiment, the R side coded bit stream 111 may correspond to a base view, and the L side coded bit stream 110 may correspond to a non base view.

Although the present embodiment describes coded bit streams for two viewpoints, it is needless to say that effects of the present invention can be achieved even with coded bit streams for three or more viewpoints.

Further, although the DPB lists 141a and 141b are managed individually for the R side coded bit stream 111 and the L side coded bit stream 110 in the present embodiment, the DPB lists 141a and 141b may be managed based on a single list, and common indexes may be assigned thereto.

Further, the syntax information stored in the DPB lists 141a and 141b in the present embodiment is an example, and is not limited by the present embodiment.

### Embodiment 4

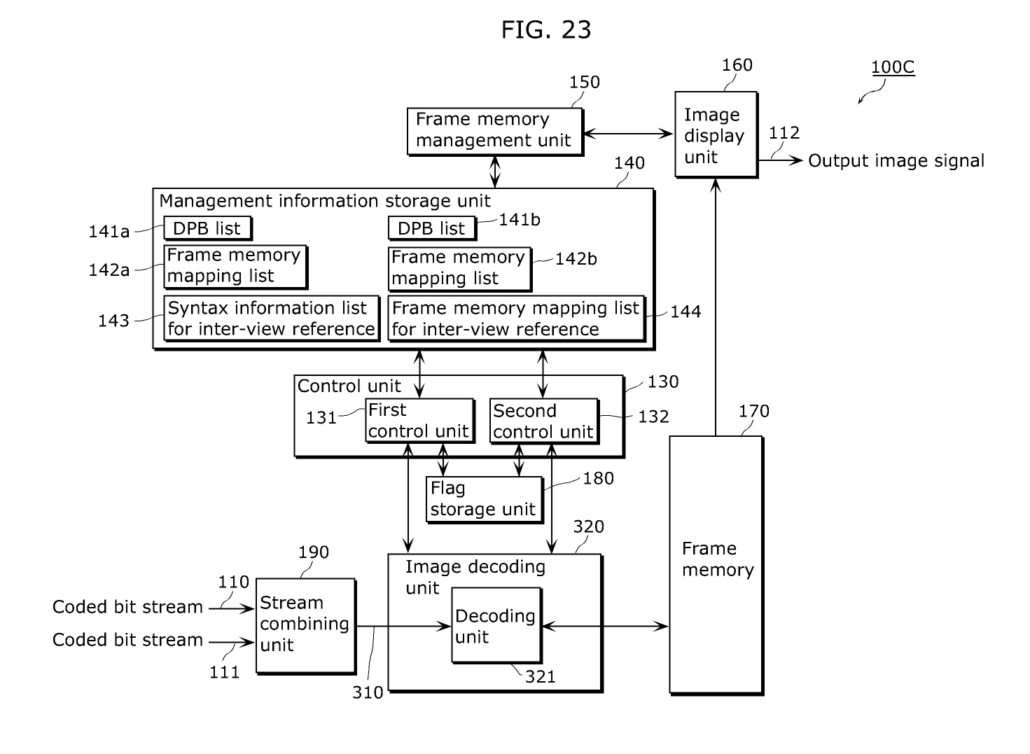

FIG. 23 is a block diagram showing a configuration of an image decoding apparatus 100C according to Embodiment 4 of the present invention. It should be noted that the same numerals are given to the same elements as those in FIG. 2, and the same description is omitted.

In addition to the configuration of the image decoding apparatus 100 shown in FIG. 2, the image decoding apparatus 100C shown in FIG. 23 further includes a stream combining unit 190. The image decoding apparatus 100C includes an image decoding unit 320, instead of the image decoding unit 120.

The stream combining unit 190 combines a coded bit stream 110 and a coded bit stream 111 into one coded bit stream 310.

Specifically, the stream combining unit 190 generates one coded bit stream 310 by alternately arranging the coded bit stream 110 and the coded bit stream 111 in units of coding previously determined.

The image decoding unit 320 includes a decoding unit 321. The decoding unit 321 alternately decodes the coded bit stream 110 and the coded bit stream 111 included in the coded bit stream 310, for each of the above units of coding. It should be noted that the configuration of the decoding unit 321 is the same as the configuration of the first decoding unit 121 and the second decoding unit 122 shown in FIG. 2.

The coded bit streams 110 and 111 input to the image decoding apparatus 100C of the present embodiment are coded using H.264-MVC. Further, the description of a relationship between a feature of the H.264-MVC coding and the configuration of the image decoding apparatus in the present embodiment is as given in Embodiment 1.

Here, an additional description of the structure of an H.264-MVC stream is given.

The H.264 standard defines separation of coded information into layers referred to as NAL units. A numeral which can be identified and is referred to as a “start code” is given to each NAL unit. Further, the type of a NAL unit can be distinguished based on the NAL header following the start code. Examples of the types of NAL units include a sequence parameter set, a picture parameter set, a slice, and the like.

According to H.264-MVC, a view (a base view or a non base view) to which a sequence parameter set, a picture parameter set, a slice, or the like mentioned above belongs can be distinguished by analyzing the NAL header.

The stream combining unit 190 analyzes the coded bit streams 110 and 111, and alternately outputs the coded bit streams 110 and 111 in predetermined units in the state of coded bit streams, thereby generating the coded bit stream 310. In the present embodiment, the stream combining unit 190 alternately outputs the coded bit streams 110 and 111 in a picture unit, starting from the L side coded bit stream 110, and thereby generates the coded bit stream 310 in which pictures are interleaved. In other words, the stream combining unit 190 arranges the coded bit stream 110 in a picture unit, out of the coded bit stream 110 and the coded bit stream 111 which are included in the same access unit, and thereafter arranges the coded bit stream 111 in a picture unit, thereby generating the coded bit stream 310.

The following is a description of the operation of the image decoding apparatus 100C in Embodiment 4 of the present invention which has a configuration in conformity with the H.264 standard and the H.264-MVC standard as described above.

In the image decoding apparatus 100C of the present embodiment, the first control unit 131 and the second control unit 132 achieve synchronization between decoding processing on the coded bit stream 310 by operating as follows.

First is a description of decoding processing on an L side picture.

In the processing steps below, the first control unit 131 controls the image decoding unit 320, and performs picture decoding processing on the L side coded bit stream 110 combined in the coded bit stream 310.

It should be noted that the procedure of processing performed by the first control unit 131 is the same as that of the processing shown in FIG. 12, and thus a description is given using FIG. 12.

First, the first control unit 131 clears the first completion flag stored in the flag storage unit 180 (S101).

Next, the first control unit 131 obtains, from the frame memory management unit 150, a base address in the frame memory 170 at which the result of decoding a decode target picture is to be stored (S102).

Next, the first control unit 131 obtains the L side DPB list 141a from the management information storage unit 140 (S103).

Next, the first control unit 131 obtains the frame memory mapping list 142a. Further, the first control unit 131 obtains the base address of a reference picture for intra-view reference, by referring to the obtained DPB list 141a and the obtained frame memory mapping list 142a (S104).

Next, the first control unit 131 sets, in the decoding unit 321, the base address for the decode target picture, the base address of the reference picture, and the DPB list 141a obtained in steps S102 to S104 described above, and starts the decoding unit 321 (S105). It should be noted that the streams are combined into one stream, and thus it is not necessary to set a decode target stream as in Embodiment 2.

Next, the decoding unit 321 obtains a reference picture based on the base address of the reference picture set in step S105, and generates a decoded picture by decoding the coded bit stream 110 using the obtained reference picture. Further, the decoding unit 321 stores the generated decoded picture at the base address for the decode target picture set in step S105. Also, the decoding unit 321 notifies the first control unit 131 that decoding processing on the decode target picture is completed (S106).

Next, the first control unit 131 obtains, from the decoding unit 321, the syntax information 113 of the picture for which decoding processing is completed in step S106 (S107).

Next, if the picture for which decoding processing is completed in step S106 is to be used as a reference picture when a succeeding picture is decoded, the first control unit 131 updates the DPB list 141a in the management information storage unit 140, using the syntax information 113 obtained in step S107 (S108).

Next, if there is a picture that is excluded from the DPB list 141a due to the update of the DPB list 141a in step S108, the first control unit 131 notifies the frame memory management unit 150 of the index 201 of that picture in the DPB list 141a. If the index 201 is notified from the first control unit 131, the frame memory management unit 150 updates the frame memory mapping list 142a (S109).

Next, the first control unit 131 stores, into the syntax information list 143 for inter-view reference, the syntax information 113 obtained in step S107 as syntax information for inter-view reference (S110).

Next, the first control unit 131 stores the base address obtained in step S102 into the frame memory mapping list 144 for inter-view reference (S111).

Next, if the input coded bit stream is data of the R side coded bit stream, the first control unit 131 once stops the L side decoding processing, and sets the first completion flag in the flag storage unit 180 (S112).

Next is a description of decoding processing on an R side picture.

After steps S101 to S112 described above, the second control unit 132 controls the image decoding unit 320, and performs decoding processing on the R side coded bit stream 111 combined in the coded bit stream 310, in the processing steps below.

It should be noted that the procedure of processing performed by the second control unit 132 is the same as that of the processing shown in FIG. 13, and thus a description is given using FIG. 13.

First, the second control unit 132 clears the second completion flag stored in the flag storage unit 180 (S201).

Next, the second control unit 132 obtains, from the syntax information list 143 for inter-view reference in the management information storage unit 140, the syntax information 113 of an L side decoded picture which can be referred to in the decoding processing on the R side coded bit stream 111, to identify a picture for inter-view reference (S202).

Next, the second control unit 132 obtains the base address of an L side decoded picture which can be referred to in the decoding processing on the R side coded bit stream 111, from the frame memory mapping list 144 for inter-view reference in the management information storage unit 140 (S203).

Next, the second control unit 132 obtains, from the frame memory management unit 150, a base address in the frame memory 170 at which the result of decoding a decode target picture (R side picture) is to be stored (S204).

Next, the second control unit 132 obtains the R side DPB list 141b from the management information storage unit 140 (S205).

Next, the second control unit 132 obtains the frame memory mapping list 142b. Further, the second control unit 132 obtains the base address of a reference picture for intra-view reference, by referring to the obtained DPB list 141b and the obtained frame memory mapping list 142b (S206).

Next, the second control unit 132 sets, in the decoding unit 321, the base address for the decode target picture, the base addresses of the reference picture for intra-view reference and the reference picture for inter-view reference, and the DPB list 141b for the decode target picture which are obtained in steps S203, S204, S205, and S206, and starts the decoding unit 321 (S207). It should be noted that the streams are combined into one stream, and thus it is not necessary to set a decode target stream as in Embodiment 2.

Next, the decoding unit 321 obtains a reference picture based on the base address for intra-view reference or for inter-view reference set in step S207, and generates a decoded picture by decoding the coded bit stream 111 using the obtained reference picture. Further, the decoding unit 321 stores the generated decoded picture at the base address for the decode target picture set in step S207. Also, the decoding unit 321 notifies the second control unit 132 that decoding processing on the picture is completed (S208).

Next, the second control unit 132 obtains, from the decoding unit 321, the syntax information 113 of the picture for which decoding is completed in step S208 (S209).

Next, the second control unit 132 updates the DPB list 141b if the picture for which decoding is completed in step S208 is to be used as a reference picture when a succeeding picture is decoded (S210). Next, when there is a picture excluded from the DPB list 141b due to the update of the DPB list 141b in step S210, the second control unit 132 notifies the frame memory management unit 150 of the index 201 of that picture in the DPB list 141b. The frame memory management unit 150 updates the frame memory mapping list 142b, if the index 201 is notified from the second control unit 132 (S211).

Next, if the input coded bit stream is data of the L side coded bit stream, the second control unit 132 once stops the R side decoding processing, and sets the second completion flag in the flag storage unit 180 (S212).

It should be noted that a relationship for one picture time among the DPB lists 141a and 141b, the frame memory mapping lists 142a and 142b, the syntax information list 143 for inter-view reference, and the frame memory mapping list 144 for inter-view reference is the same as that in Embodiment 2.

In this manner, the image decoding apparatus 100C according to Embodiment 4 of the present invention can achieve synchronization between decoding processing, by combining the coded bit streams 110 and 111 into one coded bit stream 310.

Further, the image decoding apparatus 100C according to Embodiment 4 of the present invention can be informed of syntax management information of a reference picture obtained from the L side coded bit stream 110, via the common syntax information list 143 for inter-view reference which can be accessed during decoding processing on the R side coded bit stream 111. Accordingly, the image decoding apparatus 100C can decode a bit stream coded using inter-view prediction.

It should be noted that the image decoding apparatus 100C according to Embodiment 4 of the present invention is also applicable to decoding a coded bit stream based not only on the H.264 standard, but also on other standards.

Further, although in the present embodiment, the stream combining unit 190 alternately outputs the coded bit streams 110 and 111 in picture units (frame units), thereby generating the coded bit stream 310, the stream combining unit 190 may alternately output the streams in two-field picture units in the case of a field structure, for instance. Further, the stream combining unit 190 may alternately output the coded bit streams 110 and 111 in NAL units defined by the H.264 standard, such as parameter set units (units of header decoding processing) or slice units.

In fact, the first control unit 131 and the second control unit 132 described in the present embodiment may include two processors or may be two logical threads.

Although the L side coded bit stream 110 corresponds to a base view, and the R side coded bit stream 111 corresponds to a non base view in the present embodiment, the R side coded bit stream 111 may correspond to a base view, and the L side coded bit stream 110 may correspond to a non base view.

Although the present embodiment describes coded bit streams for two viewpoints, it is needless to say that effects of the present invention can be achieved even with coded bit streams for three or more viewpoints.

Further, although the DPB lists 141a and 141b, and the frame memory mapping lists 142a and 142b are individually managed for the R side coded bit stream 111 and the L side coded bit stream 110 in the present embodiment, at least either the DPB lists 141a and 141b or the frame memory mapping lists 142a and 142b may be managed based on a single list, and common indexes may be assigned thereto.

Further, the syntax information stored in the DPB lists 141a and 141b in the present embodiment is an example, and is not limited by the present embodiment.

Further, although it is determined whether data is of the coded bit stream 110 or 111, by analyzing the NAL header in the present embodiment, the stream combining unit 190 may insert, into the coded bit stream 310, a bit string which is different from a start code and can be identified by the decoding unit 321, for example.

### Embodiment 5

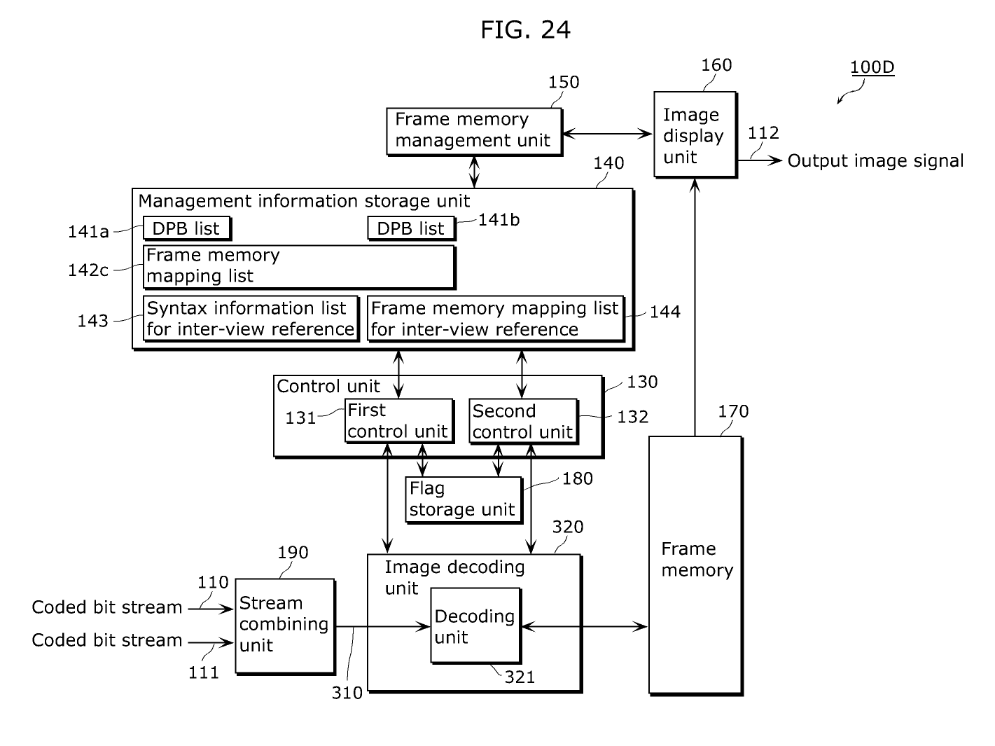

FIG. 24 is a block diagram showing a configuration of an image decoding apparatus 100D according to Embodiment 5 of the present invention. It should be noted that the same numerals are given to the same elements as those in FIG. 23, and the same description is omitted.

Specifically, in the image decoding apparatus 100D shown in FIG. 24, the configuration of a management information storage unit 240 is different from the configuration of the management information storage unit 140 shown in FIG. 23. More specifically, the management information storage unit 240 stores a frame memory mapping list 142c, instead of the frame memory mapping lists 142a and 142b shown in FIG. 23. In other words, the configuration of the management information storage unit 240 is the same as that of the management information storage unit 240 shown in FIG. 20.

Coded bit streams 110 and 111 input to the image decoding apparatus 100D of the present embodiment are coded using H.264-MVC. Further, the description of a relationship between a feature of the H.264-MVC coding and the configuration of the image decoding apparatus in the present embodiment is as given in Embodiment 1.

Now, a description is given of the operation of the image decoding apparatus 100D in Embodiment 5 of the present invention which has a configuration in conformity with the H.264 standard and the H.264-MVC standard as described above.

In the present embodiment, a frame memory is assumed to include an area in which nine pictures in total can be stored, as in Embodiment 3.

First, the image decoding apparatus 100D according to Embodiment 5 of the present invention starts decoding processing on the L side coded bit stream 110. Further, the first control unit 131 and the second control unit 132 achieve synchronization between decoding processing on the coded bit streams 110 and 111 by alternately operating as in Embodiment 4.

It should be noted that a relationship for one picture time among the DPB lists 141a and 141b, the frame memory mapping list 142c, the syntax information list 143 for inter-view reference, and the frame memory mapping list 144 for inter-view reference is the same as shown in 22.

In this manner, the image decoding apparatus 100D according to Embodiment 5 of the present invention can achieve synchronization between decoding processing, by combining the coded bit streams 110 and 111 into one coded bit stream 310.

Further, the image decoding apparatus 100D according to Embodiment 5 of the present invention can be informed of syntax management information of a reference picture obtained from the L side coded bit stream 110, via the common syntax information list 143 for inter-view reference which can be accessed during decoding processing on the R side coded bit stream 111. Accordingly, the image decoding apparatus 100D can decode a bit stream coded using inter-view prediction.

Furthermore, the image decoding apparatus 100D according to Embodiment 5 of the present invention manages the frame memory mapping list 142c in common for the L side coded bit stream 110 and the R side coded bit stream 111, thereby enabling reduction in the capacity of the frame memory and also the cost.

It should be noted that the image decoding apparatus 100D according to Embodiment 5 of the present invention is also applicable to decoding a coded bit stream based not only on the H.264 standard, but also on other standards.

Further, although in the present embodiment, the stream combining unit 190 generates the coded bit stream 310 by alternately outputting the coded bit streams 110 and 111 in picture units (frame units), the stream combining unit 190 may alternately output the streams in two-field picture units in the case of a field structure, for instance. Further, the stream combining unit 190 may alternately output the coded bit streams 110 and 111 for NAL units defined by the H.264 standard, such as parameter set units (units of header decoding processing) or slice units.

In fact, the first control unit 131 and the second control unit 132 described in the present embodiment may include two processors or may be two logical threads.

Although the L side coded bit stream 110 corresponds to a base view, and the R side coded bit stream 111 corresponds to a non base view in the present embodiment, the R side coded bit stream 111 may correspond to a base view, and the L side coded bit stream 110 may correspond to a non base view.

Although the present embodiment describes coded bit streams for two viewpoints, it is needless to say that effects of the present invention can be achieved even with coded bit streams for three or more viewpoints.

Although the DPB lists 141a and 141b are managed individually for the R side coded bit stream 111 and the L side coded bit stream 110 in the present embodiment, the DPB lists 141a and 141b may be managed based on a single list, and common indexes may be assigned thereto.

Further, the syntax information stored in the DPB lists 141a and 141b in the present embodiment is an example, and is not limited by the present embodiment.

Further, although it is determined whether data is of the coded bit stream 110 or 111, by analyzing the NAL header in the present embodiment, the stream combining unit 190 may insert, into the coded bit stream 310, a bit string which is different from a start code and can be identified by the decoding unit 321, for example.

### Embodiment 6

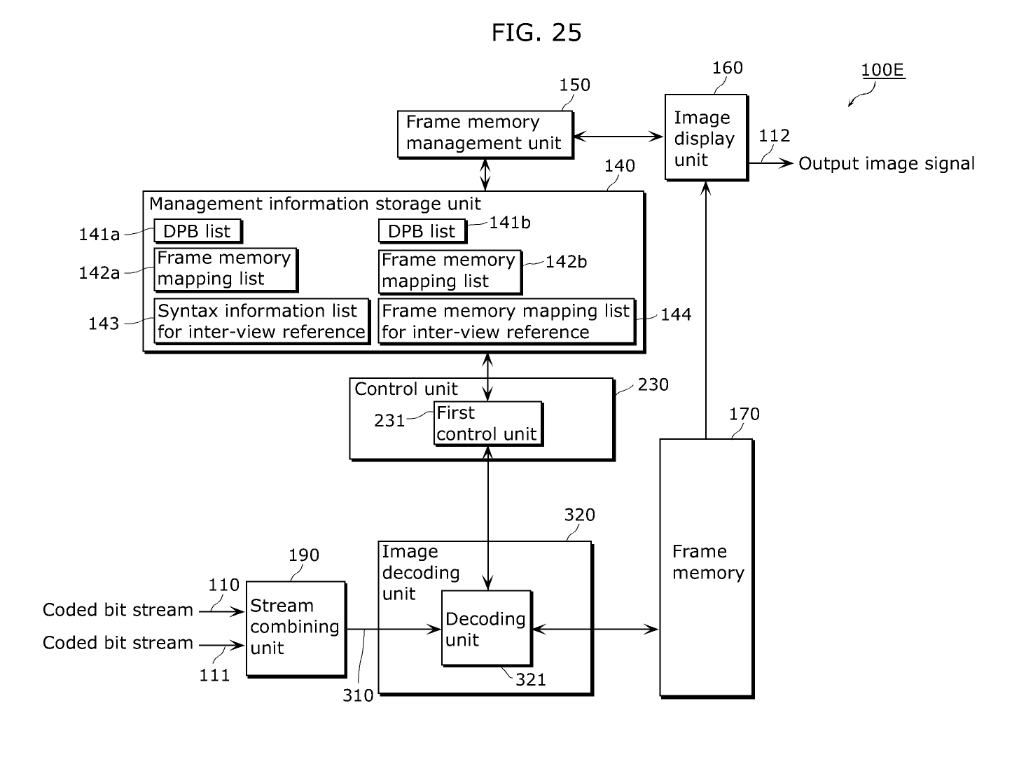

FIG. 25 is a block diagram showing a configuration of an image decoding apparatus 100E according to Embodiment 6 of the present invention. It should be noted that the same numerals are given to the same elements as those in FIG. 23, and the same description is omitted.

In the image decoding apparatus 100E shown in FIG. 25, the configuration of a control unit 230 is different from the configuration of the control unit 130 shown in FIG. 23. Further, a difference from the image decoding apparatus 100C shown in FIG. 23 is that the image decoding apparatus 100E does not include the flag storage unit 180.

The control unit 230 includes a first control unit 231.

The first control unit 231 controls decoding processing on a coded bit stream 310 in which a coded bit stream 110 and a coded bit stream 111 are combined.

The first control unit 231 controls decoding processing on the coded bit stream 110 combined in the coded bit stream 310, based on the DPB list 141a, the syntax information list 143 for inter-view reference, the frame memory mapping list 142a, and the frame memory mapping list 144 for inter-view reference. Further, the first control unit 231 controls decoding processing on the coded bit stream 111 combined in the coded bit stream 310, based on the DPB list 141b, the syntax information list 143 for inter-view reference, the frame memory mapping list 142b, and the frame memory mapping list 144 for inter-view reference.

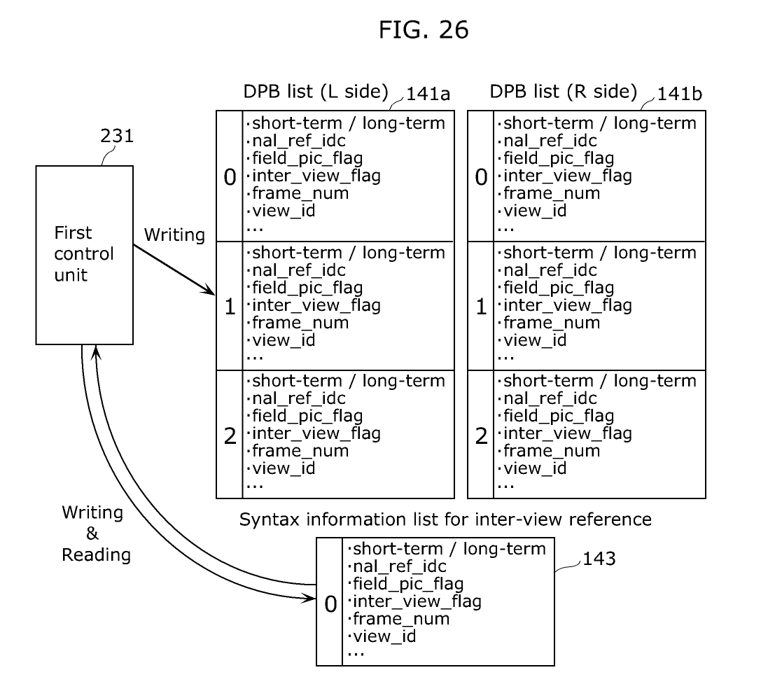

FIG. 26 shows processing performed by the first control unit 231.

As in FIG. 26, the first control unit 231 stores, into the syntax information list 143 for inter-view reference, the syntax information 113 of a reference picture obtained from the L side coded bit stream 110 which corresponds to a base view. Further, the first control unit 231 obtains the syntax information list 143 for inter-view reference when the R side coded bit stream 111 which corresponds to a non base view is decoded.

The coded bit streams 110 and 111 input to the image decoding apparatus 100E of the present embodiment are coded using H.264-MVC. Further, the description of a relationship between a feature of the H.264-MVC coding and the configuration of the image decoding apparatus in the present embodiment is as given in Embodiment 1.

Now, a description is given of the operation of the image decoding apparatus 100E in Embodiment 6 of the present invention which has a configuration in conformity with the H.264 standard and the H.264-MVC standard as described above.

The image decoding apparatus 100E in the present embodiment performs decoding processing on the coded bit stream 310 by operating as follows.

First is a description of decoding processing on an L side picture.

In the following processing steps, the first control unit 231 controls the decoding unit 321, and performs picture decoding processing on the L side coded bit stream 110 combined in the coded bit stream 310.

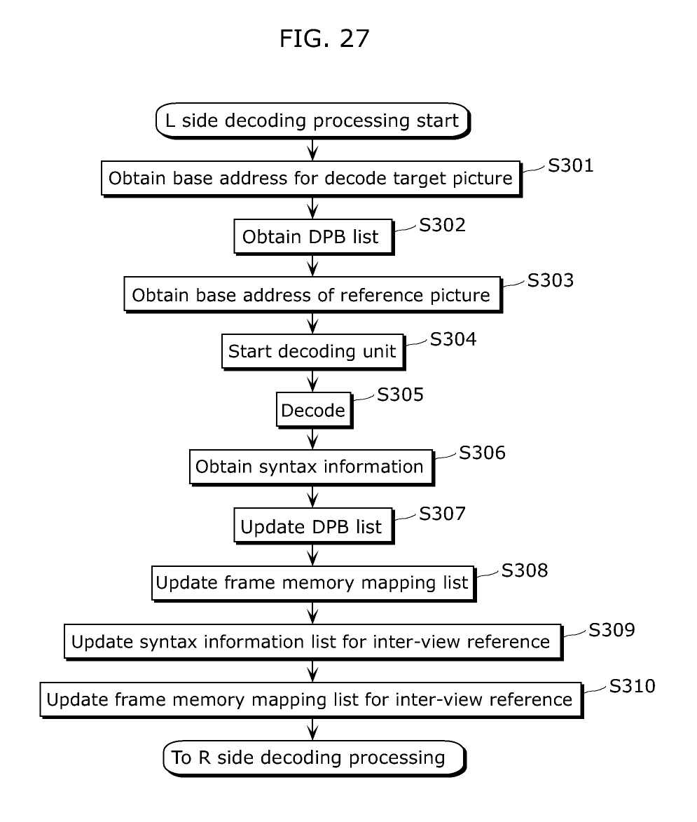

FIG. 27 is a flowchart of L side decoding processing performed by the image decoding apparatus 100E.

First, the first control unit 231 obtains, from the frame memory management unit 150, the base address in the frame memory 170 at which the result of decoding a decode target picture is to be stored (S301).

Next, the first control unit 231 obtains the L side DPB list 141a from the management information storage unit 140 (S302).

Next, the first control unit 231 obtains the frame memory mapping list 142a. Further, the first control unit 231 obtains the base address of a reference picture for intra-view reference, by referring to the obtained DPB list 141a and the obtained frame memory mapping list 142a (S303).

Next, the first control unit 231 sets, in the decoding unit 321, the base address for the decode target picture, the base address of a reference picture, and the DPB list 141a which are obtained in steps S301 to S303 described above, and starts the decoding unit 321 (S304).

Next, the decoding unit 321 obtains a reference picture based on the base address of the reference picture set in step S304, and decodes the coded bit stream 110 using the obtained reference picture, thereby generating a decoded picture. Further, the decoding unit 321 stores the generated decoded picture at the base address for the decode target picture set in step S304. Also, the decoding unit 321 notifies the first control unit 231 that decoding processing on the decode target picture is completed (S305).

Next, the first control unit 231 obtains, from the decoding unit 321, the syntax information 113 of a picture for which decoding processing is completed in step S305 (S306).

Next, if the picture for which decoding processing is completed in step S304 is to be used as a reference picture when a succeeding picture is decoded, the first control unit 231 updates the DPB list 141a in the management information storage unit 140, using the syntax information 113 obtained in step S306 (S307).

Next, if there is a picture that is excluded from the DPB list 141a due to the update of the DPB list 141a in step S307, the first control unit 231 notifies the frame memory management unit 150 of the index 201 of that picture in the DPB list 141a. If the index 201 is notified from the first control unit 231, the frame memory management unit 150 updates the frame memory mapping list 142a (S308).

Next, the first control unit 231 stores, into the syntax information list 143 for inter-view reference, the syntax information 113 obtained in step S306 as syntax information for inter-view reference (S309).

Next, the first control unit 231 stores the base address obtained in step S301 into the frame memory mapping list 144 for inter-view reference (S310).

Further, if the input coded bit stream is data of the R side coded bit stream, the first control unit 231 starts R side decoding processing next.

Next is a description of decoding processing on an R side picture.

After steps S401 to S410 described above, the first control unit 231 controls the image decoding unit 320, and performs decoding processing on the R side coded bit stream 111 combined in the coded bit stream 310, in the processing steps below.

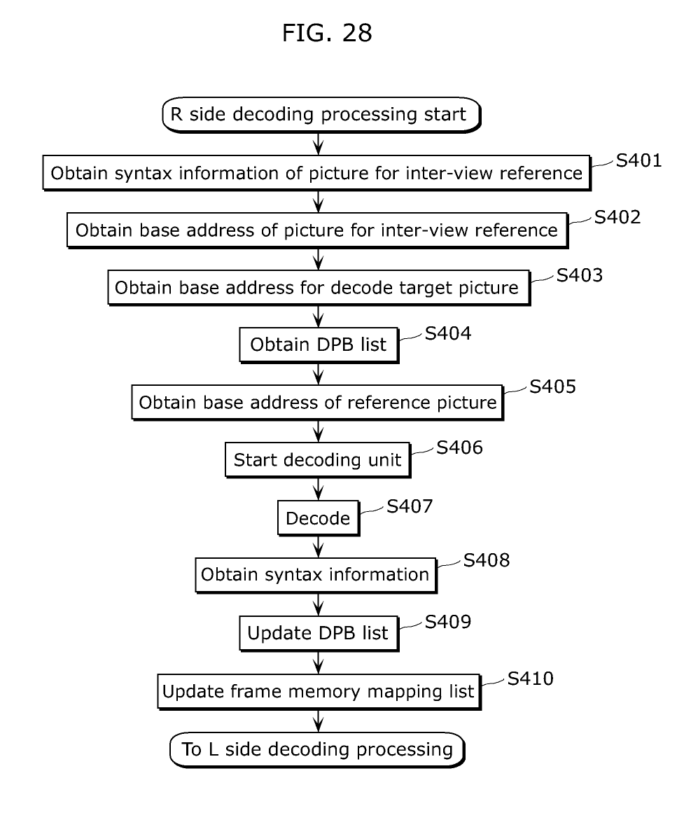

FIG. 28 is a flowchart of R side decoding processing performed by the image decoding apparatus 100E.

First, the first control unit 231 obtains, from the syntax information list 143 for inter-view reference in the management information storage unit 140, the syntax information 113 of an L side decoded picture which can be referred to in decoding processing on the R side coded bit stream 111, and identifies an inter-view reference picture (S401).

Next, the first control unit 231 obtains the base address of an L side decoded picture which can be referred to in decoding processing on the R side coded bit stream 111, from the frame memory mapping list 144 for inter-view reference in the management information storage unit 140 (S402).

Next, the first control unit 231 obtains the base address in the frame memory 170 at which the result of decoding a decode target picture (R side picture) is to be stored, from the frame memory management unit 150 (S403).

Next, the first control unit 231 obtains the R side DPB list 141b from the management information storage unit 140 (S404).

Next, the first control unit 231 obtains the frame memory mapping list 142b. Further, the first control unit 231 obtains the base address of a reference picture for intra-view reference, by referring to the obtained DPB list 141b and the obtained frame memory mapping list 142b (S405).

Next, the first control unit 231 sets the base address for the decode target picture, the base addresses of the reference picture for intra-view reference and the reference picture for inter-view reference, and the DPB list 141b for the decode target picture which are obtained in steps S402, S403, S404, and S405 in the decoding unit 321, and starts the decoding unit 321 (S406).

Next, the decoding unit 321 obtains a reference picture based on the base address for intra-view reference or for inter-view reference set in step S406, and generates a decoded picture by decoding the coded bit stream 111 using the obtained reference picture. Further, the decoding unit 321 stores the generated decoded picture at the base address for the decode target picture set in step S406. Also, the decoding unit 321 notifies the first control unit 231 that decoding processing on that picture is completed (S407).

Next, the first control unit 231 obtains the syntax information 113 of the picture for which decoding is completed in step S407, from the decoding unit 321 (S408).

Next, the first control unit 231 updates the DPB list 141b, if the picture for which decoding is completed in step S407 is to be used as a reference picture when a succeeding picture is decoded (S409).

Next, when there is a picture excluded from the DPB list 141b due to the update of the DPB list 141b in step S409, the first control unit 231 notifies the frame memory management unit 150 of the index 201 of that picture in the DPB list 141b. The frame memory management unit 150 updates the frame memory mapping list 142b, if the index 201 is notified from the first control unit 231 (S410).

The first control unit 231 starts L side decoding processing next, if the input coded bit stream is data of the L side coded bit stream.

It should be noted that a relationship for one picture time among the DPB lists 141a and 141b, the frame memory mapping lists 142a and 142b, the syntax information list 143 for inter-view reference, and the frame memory mapping list 144 for inter-view reference is the same as that in Embodiment 2.

In this manner, the image decoding apparatus 100E according to Embodiment 6 of the present invention can achieve synchronization between decoding processing, by combining the coded bit streams 110 and 111 into one coded bit stream 310.

The image decoding apparatus 100E according to Embodiment 6 of the present invention can be informed of syntax management information of a reference picture obtained from the L side coded bit stream 110 via the syntax information list 143 for inter-view reference, by controlling the coded bit streams 110 and 111 using a single first control unit 231. Accordingly, the image decoding apparatus 100E can decode a bit stream coded using inter-view prediction.

It should be noted that the image decoding apparatus 100E according to Embodiment 6 of the present invention is also applicable to decoding a coded bit stream based not only on the H.264 standard, but also on other standards.

Further, although in the present embodiment, the stream combining unit 190 generates the coded bit stream 310 by alternately outputting the coded bit streams 110 and 111 in picture units (frame units), the stream combining unit 190 may alternately output the streams in two-field picture units in the case of a field structure, for instance. Also, the stream combining unit 190 may alternately output the coded bit streams 110 and 111 in NAL units defined by the H.264 standard, such as parameter set units (units of header decoding processing) or slice units.

In fact, the first control unit 231 described in the present embodiment may include one processor or may be one logical thread.

Although the L side coded bit stream 110 corresponds to a base view, and the R side coded bit stream 111 corresponds to a non base view in the present embodiment, the R side coded bit stream 111 may correspond to a base view, and the L side coded bit stream 110 may correspond to a non base view.

Although the present embodiment describes coded bit streams for two viewpoints, it is needless to say that effects of the present invention can be achieved even with coded bit streams for three or more viewpoints.

Further, although the DPB lists 141a and 141b, and the frame memory mapping lists 142a and 142b are individually managed for the R side coded bit stream 111 and the L side coded bit stream 110 in the present embodiment, at least either the DPB lists 141a and 141b or the frame memory mapping lists 142a and 142b may be managed based on a single list, and common indexes may be assigned thereto.

Further, the syntax information stored in the DPB lists 141a and 141b in the present embodiment is an example, and is not limited by the present embodiment.

Further, although it is determined whether data is of the coded bit stream 110 or 111, by analyzing the NAL header in the present embodiment, the stream combining unit 190 may insert, into the coded bit stream 310, a bit string which is different from a start code and can be identified by the decoding unit 321, for example.

### Embodiment 7

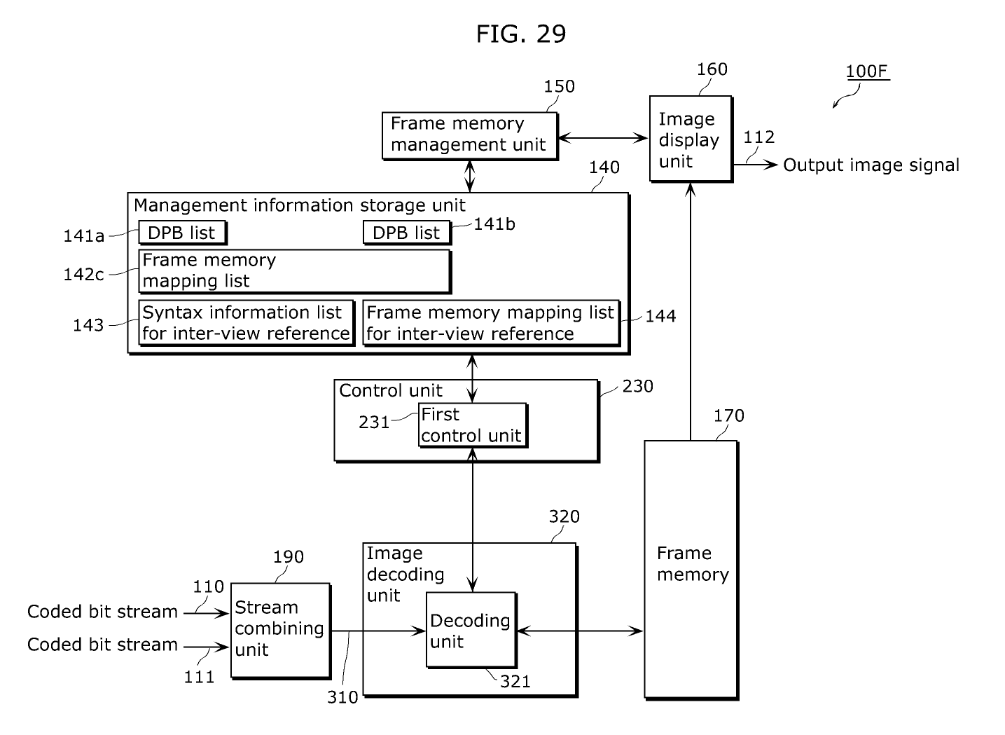

FIG. 29 is a block diagram showing a configuration of an image decoding apparatus 100F according to Embodiment 7 of the present invention. It should be noted that the same numerals are given to the same elements as those in FIG. 25, and the same description is omitted.

Specifically, in the image decoding apparatus 100F shown in FIG. 29, the configuration of a management information storage unit 240 is different from the configuration of the management information storage unit 140 shown in FIG. 25. More specifically, the management information storage unit 240 stores a frame memory mapping list 142c instead of the frame memory mapping lists 142a and 142b shown in FIG. 25. In other words, the configuration of the management information storage unit 240 is the same as that of the management information storage unit 240 shown in FIG. 20.

Coded bit streams 110 and 111 input to the image decoding apparatus 100F in the present embodiment are coded using H.264-MVC. Further, the description of a relationship between a feature of the H.264-MVC coding and the configuration of the image decoding apparatus in the present embodiment is as given in Embodiment 1.

Now, a description is given of the operation of the image decoding apparatus 100F in Embodiment 7 of the present invention which has a configuration in conformity with the H.264 standard and the H.264-MVC standard as described above.

In the present embodiment, it is assumed that the frame memory 170 includes an area in which nine pictures in total can be stored, as in Embodiment 3.

First, the image decoding apparatus 100F in the present embodiment starts decoding processing on the L side coded bit stream 110. The first control unit 231 performs decoding processing on the coded bit stream 310 by operating as in Embodiment 6.

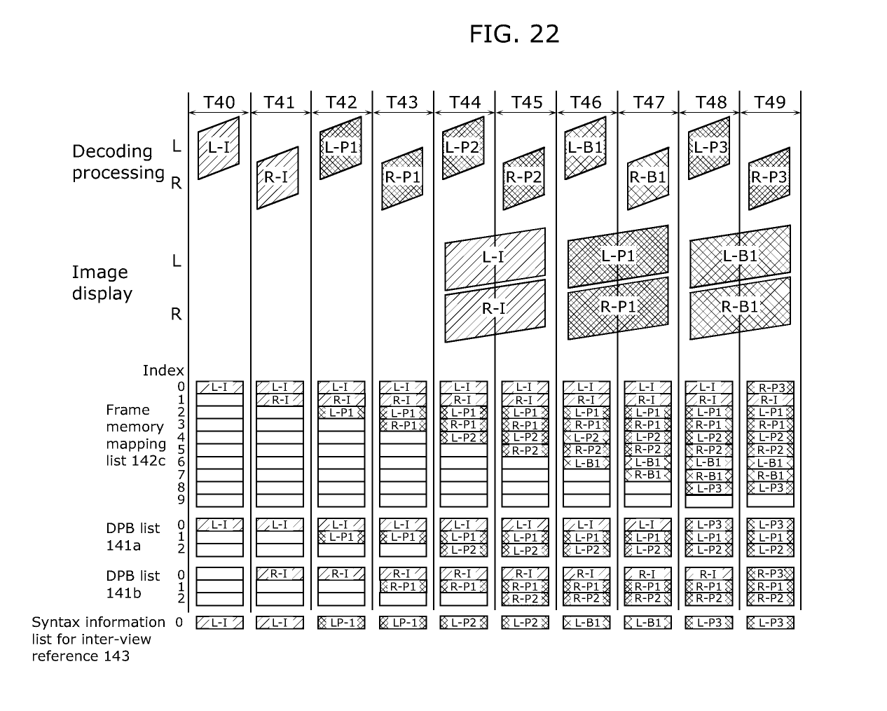

It should be noted that a relationship for one picture time among the DPB lists 141a and 141b, the frame memory mapping lists 142a and 142b, the syntax information list 143 for inter-view reference, and the frame memory mapping list 144 for inter-view reference is the same as shown in FIG. 22.

In this manner, the image decoding apparatus 100F according to Embodiment 7 of the present invention can achieve synchronization between decoding processing, by combining the coded bit streams 110 and 111 into one coded bit stream 310.

The image decoding apparatus 100F according to Embodiment 7 of the present invention can be informed of syntax management information of a reference picture obtained from the L side coded bit stream 110 via the syntax information list 143 for inter-view reference, by controlling the coded bit streams 110 and 111 using a single first control unit 231. Accordingly, the image decoding apparatus 100F can decode a bit stream coded using inter-view prediction.

Furthermore, the image decoding apparatus 100F according to Embodiment 7 of the present invention manages the frame memory mapping list 142c in common for the L side coded bit stream 110 and the R side coded bit stream 111, thereby reducing the capacity of the frame memory 170. Therefore, the cost of the image decoding apparatus 100F can be reduced.

It should be noted that the image decoding apparatus 100F according to Embodiment 7 of the present invention is also applicable to decoding a coded bit stream based not only on the H.264 standard, but also on other standards.

Further, although in the present embodiment, the stream combining unit 190 generates the coded bit stream 310 by alternately outputting the coded bit streams 110 and 111 in picture units (frame units), the stream combining unit 190 may alternately output the streams in two-field picture units in the case of a field structure, for instance. Further, the stream combining unit 190 may alternately output the coded bit streams 110 and 111 in NAL units defined by the H.264 standard, such as parameter set units (units of header decoding processing) or slice units.

In fact, the first control unit 231 described in the present embodiment may include one processor or may be one logical thread.

Although the L side coded bit stream 110 corresponds to a base view, and the R side coded bit stream 111 corresponds to a non base view in the present embodiment, the R side coded bit stream 111 may correspond to a base view, and the L side coded bit stream 110 may correspond to a non base view.

Although the present embodiment describes coded bit streams for two viewpoints, it is needless to say that effects of the present invention can be achieved even with coded bit streams for three or more viewpoints.

Although the DPB lists 141a and 141b are managed individually for the R side coded bit stream 111 and the L side coded bit stream 110 in the present embodiment, the DPB lists 141a and 141b may be managed based on a single list, and common indexes may be assigned thereto.

Further, the syntax information stored in the DPB lists 141a and 141b in the present embodiment is an example, and is not limited by the present embodiment.

Further, although it is determined whether data is of the coded bit stream 110 or 111, by analyzing the NAL header in the present embodiment, the stream combining unit 190 may insert, into the coded bit stream 310, a bit string which is different from a start code and can be identified by the decoding unit 321, for example.

The processing units included in the image decoding apparatuses according to Embodiments 1 to 7 described above are fabricated as LSIs which are typical integrated circuits. These may be individually formed into a single chip, or formed into a single chip so as to include some or all of the units.

Furthermore, the method of circuit integration is not limited to LSIs, and implementation through a dedicated circuit or a general-purpose processor is also possible. A field programmable gate array (FPGA) that allows programming after LSI manufacturing or a reconfigurable processor that allows reconfiguration of the connections and settings of the circuit cells inside the LSI may also be used.

Some or all of the functions of the image decoding apparatuses according to Embodiments 1 to 7 of the present invention may be realized by a processor such as a CPU executing a program.

Furthermore, the present invention may be the above program or may be a recording medium on which the above program is recorded. In addition, it goes without saying that the above program can be distributed via a transmission medium such as the Internet.

At least some of the functions of the image decoding apparatuses according to the above Embodiments 1 to 7 and the functions of modifications thereof may be combined.

All the numbers used above are used as examples in order to specifically describe the present invention, and do not limit the present invention. The connection relationship among the constituent elements is used as an example in order to specifically describe the present invention, and does not limit the connection relationship for realizing the functionality of the present invention.

The configurations of the above image decoding apparatuses are described as examples to specifically describe the present invention, and the image decoding apparatuses according to the present invention do not necessarily need to include all the above configurations. In other words, it is sufficient for the image decoding apparatuses according to the present invention to include only a minimum configuration that can realize the effects of the present invention.

Similarly, the image decoding method executed by the above image decoding apparatuses is used as an example to specifically describe the present invention, and the image decoding method according to the present invention does not necessarily need to include all the above steps. In other words, it is sufficient for the image decoding method according to the present invention to include only the smallest number of steps that can realize the effects of the present invention. Further, the order of executing the above steps is an example to specifically describe the present invention, and may be an order other than the above. Also, some of the above steps may be executed simultaneously with (in parallel to) other steps.

Furthermore, the present invention also includes various modifications obtained by applying changes to the embodiments, which can be conceived by a person skilled in the art, as long as the modifications do not depart from the scope of the present invention.

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

The present invention is applicable to image decoding apparatuses, and is particularly useful for stereoscopic image systems using a plurality of coded bit streams compressed in accordance with a coding scheme using inter-view prediction, such as H.264-MVC. For example, the present invention is useful for optical disk reproducing apparatuses, optical disk recording apparatuses, digital television receiving apparatuses, movie apparatuses, and cellular phones.

1. An image decoding apparatus which decodes a first coded signal obtained by coding first image signals corresponding to a first viewpoint, and a second coded signal obtained by coding second image signals corresponding to a second viewpoint different from the first viewpoint, said apparatus comprising:
an image decoding unit configured to decode the first coded signal and the second coded signal by referring to reference images, to generate first decoded image signals and second decoded image signals; and
a frame memory for storing the first decoded image signals and the second decoded image signals as the reference images,
wherein said image decoding unit is configured to decode the first coded signal by referring to one of the first decoded image signals as the reference image, and decode the second coded signal by referring to one of the first decoded image signals or one of the second decoded image signals as the reference image,
said image decoding apparatus further comprising:
a management information storage unit configured to store first management information for identifying areas in each of which one of the first decoded image signals is stored, and second management information for identifying areas in each of which one of the second decoded image signals is stored, the areas being included in said frame memory; and
a control unit configured to notify, by referring to the first management information, said image decoding unit of an area in which a reference image to be referred to when the first coded signal is decoded is stored, and notify, by referring to the first management information and the second management information, said image decoding unit of an area in which a reference image to be referred to when the second coded signal is decoded is stored, the areas being included in said frame memory.

2. The image decoding apparatus according to claim 1,
wherein the first management information includes:
a first syntax information list including, for each of the first decoded image signals, first syntax information included in the first coded signal and used for identifying the first decoded image signal, and a first identification number associated with the first syntax information; and
a first mapping list showing, for each of the first decoded image signals, a correspondence between the first identification number and an area in said frame memory,
said control unit is configured to (i) obtain the first identification number corresponding to one of the first decoded image signals by referring to the first syntax information list, (ii) obtain an area included in said frame memory and corresponding to the obtained first identification number by referring to the first mapping list, and (iii) notify said image decoding unit of the obtained area in said frame memory, as an area which is included in said frame memory and in which a corresponding one of the reference images is stored,
the second management information includes:
a second syntax information list including, for each of the second decoded image signals, second syntax information included in the second coded signal and used for identifying the second decoded image signal, and a second identification number associated with the second syntax information; and
a second mapping list showing, for each of the second decoded image signals, a correspondence between the second identification number and an area in said frame memory, and
said control unit is configured to (i) obtain the second identification number corresponding to one of the second decoded image signals by referring to the second syntax information list, (ii) obtain an area included in said frame memory and corresponding to the obtained second identification number by referring to the second mapping list, and (iii) notify said image decoding unit of the obtained area in said frame memory, as an area which is included in said frame memory and in which a corresponding one of the reference images is stored.

3. The image decoding apparatus according to claim 2,
wherein the first syntax information and the second syntax information are syntax information necessary when a decoded picture buffer (DPB) defined by the H.264 standard is updated.

4. The image decoding apparatus according to claim 2,
wherein the first syntax information list includes:
a syntax information list for intra-view reference including the first syntax information and the first identification number, for each of the first decoded image signals to be referred to when said image decoding unit decodes the first coded signal; and
a syntax information list for inter-view reference including the first syntax information and the first identification number, for each of the first decoded image signals to be referred to when said image decoding unit decodes the second coded signal,
when said image decoding unit decodes the first coded signal, said control unit is configured to (i) obtain the first identification number corresponding to one of the first decoded image signals by referring to the syntax information list for intra-view reference, (ii) obtain an area included in said frame memory and corresponding to the obtained first identification number by referring to the first mapping list, and (iii) notify said image decoding unit of the obtained area in said frame memory, as an area which is included in said frame memory and in which a corresponding one of the reference images is stored, and
when said image decoding unit decodes the second coded signal, said control unit is configured to (i) obtain the first identification number corresponding to one of the first decoded image signals by referring to the syntax information list for inter-view reference, (ii) obtain an area included in said frame memory and corresponding to the obtained first identification number by referring to the first mapping list, and (iii) notify said image decoding unit of the obtained area in said frame memory, as an area which is included in said frame memory and in which a corresponding one of the reference images is stored.

5. The image decoding apparatus according to claim 4,
wherein the first mapping list includes:
a mapping list for intra-view reference showing a correspondence between the first identification number and an area in said frame memory, for each of the first decoded image signals to be referred to when said image decoding unit decodes the first coded signal; and
a mapping list for inter-view reference showing a correspondence between the first identification number and an area in said frame memory, for each of the first decoded image signals to be referred to when said image decoding unit decodes the second coded signal,
when said image decoding unit decodes the first coded signal, said control unit is configured to (i) obtain the first identification number corresponding to one of the first decoded image signals by referring to the syntax information list for intra-view reference, (ii) obtain an area included in said frame memory and corresponding to the obtained first identification number by referring to the mapping list for intra-view reference, and (iii) notify said image decoding unit of the obtained area in said frame memory, as an area which is included in said frame memory and in which a corresponding one of the reference images is stored, and
when said image decoding unit decodes the second coded signal, said control unit is configured to (i) obtain the first identification number corresponding to one of the first decoded image signals by referring to the syntax information list for inter-view reference, (ii) obtain an area included in said frame memory and corresponding to the obtained first identification number by referring to the mapping list for inter-view reference, and (iii) notify said image decoding unit of the obtained area in said frame memory, as an area which is included in said frame memory and in which a corresponding one of the reference images is stored.

6. The image decoding apparatus according to claim 2, further comprising
an image display unit configured to output the first decoded image signals and the second decoded image signals stored in said frame memory to an outside,
wherein the first mapping list further includes, for each of the first decoded image signals, first image display information indicating whether the first decoded image signal has been output to the outside by said image display unit, and first reference information indicating whether the first decoded image signal is to be used as the reference image, and
when the first image display information corresponding to one of the first decoded image signals indicates that the first decoded image signal has been output to the outside, and the first reference information corresponding to the first decoded image signal indicates that the first decoded image signal is not to be used as the reference image, said control unit is configured to store, into an area which is included in said frame memory and in which the first decoded image signal has been stored, a first decoded image signal newly decoded by said image decoding unit.

7. The image decoding apparatus according to claim 1,
wherein said image decoding unit includes:
a first decoding unit configured to generate the first decoded image signals by decoding the first coded signal; and
a second decoding unit configured to generate the second decoded image signals by decoding the second coded signal, and
after both said first decoding unit and said second decoding unit complete decoding processing on the first coded signal and on the second coded signal, respectively, for a unit of decoding processing previously determined, said control unit is configured to cause said first decoding unit and said second decoding unit to start decoding processing for the next unit of decoding processing.

8. The image decoding apparatus according to claim 7, further comprising
a flag storage unit for storing a first completion flag and a second completion flag,
wherein said control unit includes:
a first control unit configured to control said first decoding unit, and store the first completion flag into said flag storage unit when decoding processing on the first coded signal for the unit of decoding processing by said first decoding unit is completed; and
a second control unit configured to control said second decoding unit, and store the second completion flag into said flag storage unit when decoding processing on the second coded signal for the unit of decoding processing by said second decoding unit is completed,
when decoding processing on the first coded signal for the unit of decoding processing by said first decoding unit is completed, and the second completion flag is stored in said flag storage unit, said first control unit is configured to cause said first decoding unit to start decoding processing on the first coded signal for the next unit of decoding processing, and
when decoding processing on the second coded signal for the unit of decoding processing by said second decoding unit is completed, and the first completion flag is stored in said flag storage unit, said second control unit is configured to cause said second decoding unit to start decoding processing on the second coded signal for the next unit of decoding processing.

9. The image decoding apparatus according to claim 1,
wherein said image decoding unit includes:
a selection unit configured to select one of the first coded signal and the second coded signal; and
a decoding unit configured to decode the first coded signal or the second coded signal selected by said selection unit, and
said control unit is configured to (i) cause said selection unit to select one of the first coded signal and the second coded signal, and (ii) cause, after decoding processing on the selected signal for a unit of decoding processing previously determined is completed, said selection unit to select the other of the first coded signal and the second coded signal.

10. The image decoding apparatus according to claim 9, further comprising
a flag storage unit for storing a first completion flag and a second completion flag,
wherein said control unit includes:
a first control unit configured to control said first decoding unit, and store the first completion flag into said flag storage unit when decoding processing on the first coded signal for the unit of decoding processing by said first decoding unit is completed; and
a second control unit configured to control said second decoding unit, and store the second completion flag into said flag storage unit when decoding processing on the second coded signal for the unit of decoding processing by said second decoding unit is completed,
when the second completion flag is stored in said flag storage unit, said first control unit is configured to cause said decoding unit to start decoding processing on the first coded signal for the next unit of decoding processing, and
when the first completion flag is stored in said flag storage unit, said second control unit is configured to cause said decoding unit to start decoding processing on the second coded signal for the next unit of decoding processing.

11. The image decoding apparatus according to claim 1, further comprising
a combining unit configured to generate a third coded signal by alternately arranging the first coded signal and the second coded signal each in a unit of coding previously determined,
wherein said image decoding unit is configured to alternately decode the first coded signal and the second coded signal included in the third coded signal for the unit of coding.

12. The image decoding apparatus according to claim 11,
wherein the unit of coding is one of a frame unit, a field unit, and a slice unit.

13. The image decoding apparatus according to claim 11,
wherein among the first coded signal and the second coded signal which correspond to each other and are each in the unit of coding, said combining unit is configured to generate the third coded signal by arranging the first coded signal in the unit of coding, and thereafter arranging the second coded signal which is in the unit of coding and corresponds to the first coded signal.

14. The image decoding apparatus according to claim 7,
wherein the unit of decoding processing is one of a frame unit, a field unit, a unit of header decoding processing, and a slice unit.

15. An image decoding method for decoding a first coded signal obtained by coding first image signals corresponding to a first viewpoint, and a second coded signal obtained by coding second image signals corresponding to a second viewpoint different from the first viewpoint, said method comprising:
decoding the first coded signal and the second coded signal by referring to reference images, to generate first decoded image signals and second decoded image signals; and
storing, into a frame memory, the first decoded image signals and the second decoded image signals as the reference images,
wherein in said decoding, the first coded signal is decoded by referring to one of the first decoded image signals as the reference image, and the second coded signal is decoded by referring to one of the first decoded image signals or one of the second decoded image signals as the reference image,
said image decoding method further comprising:
storing first management information for identifying areas in each of which one of the first decoded image signals is stored, and second management information for identifying areas in each of which one of the second decoded image signals is stored, the areas being included in the frame memory; and
notifying in said decoding, (i) an area in which a reference image to be referred to when the first coded signal is decoded is stored, by referring to the first management information, and (ii) an area in which a reference image to be referred to when the second coded signal is decoded is stored, by referring to the first management information and the second management information, the areas being included in the frame memory.
